(19) United States
(12) Patent Application Publication
(10) Pub. No.: US 2005/0065928 A1
(43) Pub. Date: Mar. 24, 2005

(54) Content performance assessment optimization for search listings in wide area network searches

(76) Inventors: Kurt Mortensen, Glendale, CA (US); Dominic Dough-Ming Cheung, South Pasadena, CA (US); Alan E. Lang, Redondo Beach, CA (US); Scott Williams Snell, Beverly Hills, CA (US); Jie Zhang, Saugus, CA (US); Pierre W. Wang, Culver City, CA (US)

Correspondence Address: JAMES D IVEY, 3025 TOTTERDELL STREET, OAKLAND, CA, 94611-1742, US

(21) Appl. No.: 10/910,780

(22) Filed: Aug. 2, 2004

Related U.S. Application Data
(63) Continuation-in-part of application No. 10/429,208, filed on May 2, 2003.

(51) Int. Cl. G06F 7/00

(52) U.S. Cl. 707/5

(57) ABSTRACT

A system and method for improving the relevance of search results given by, and favorable user experience with, a search engine by automatically detecting and removing search listings which are unusually infrequently selected by users from among other search listings. Data representing presentation of individual search listings as part of search results and data representing selection of such search listing by a user are accumulated and analyzed to evaluate performance of the search listing. Rates of selection of search listings are compared to rates of selections of search listings in similar and different positions within search results sets. Search listings with unusually low selection rates are marked from removal from the search database and/or are demoted from generalizing matching mechanisms to more specific matching mechanisms. Parameters of the accumulation and performance evaluation are adjusted according to the search volume of the search listing.

### SPECIFICATION

This is a continuation-in-part of U.S. patent application Ser. No. 10/429,208 filed May 2, 2003.

### FIELD OF THE INVENTION

This invention relates to the field of automated document content analysis, and more specifically to a mechanism for automated performance indexing and optimization of search listings in a wide area network search engine.

### BACKGROUND OF THE INVENTION

The Internet is a wide area network having a truly global reach, interconnecting computers all over the world. That portion of the Internet generally known as the World Wide Web is a collection of inter-related data whose magnitude is truly staggering. The content of the World Wide Web (sometimes referred to as “the Web”) includes, among other things, documents of the known HTML (Hyper-Text Mark-up Language) format which are transported through the Internet according to the known protocol, HTTP (Hyper-Text Transport Protocol).

The breadth and depth of the content of the Web is amazing and overwhelming to anyone hoping to find specific information therein. Accordingly, an extremely important component of the Web is a search engine. As used herein, a search engine is an interactive system for locating content relevant to one or more user-specified search terms, which collectively represent a search query. Through the known Common Gateway Interface (CGI), the Web can include content which is interactive, i.e., which is responsive to data specified by a human user of a computer connected to the Web. A search engine receives a search query of one or more search terms from the user and presents to the user a list of one or more documents which are determined to be relevant to the search query.

Search engines dramatically improve the efficiency with which users can locate desired information on the Web. As a result, search engines are one of the most commonly used resources of the Internet. An effective search engine can help a user locate very specific information within the billions of documents currently represented within the Web. The critical function and raison d'etre of search engines is to identify the few most relevant results among the billions of available documents given a few search terms of a user's query and to do so in as little time as possible.

Generally, search engines maintain a database of records associating search terms with information resources on the Web. Search engines acquire information about the contents of the Web primarily in several common ways. The most common is generally known as crawling the Web and the second is by submission of such information by a provider of such information or by third-parties (i.e., neither a provider of the information nor the provider of the search engine). Another common way for search engines to acquire information about the content of the Web is for human editors to create indices of information based on their review.

To understand crawling, one must first understand that HTML documents can include references, commonly referred to as links, to other information. Anyone who has “clicked on” a portion of a document to cause display of a referenced document has activated such a link. Crawling the Web generally refers to an automated process by which documents referenced by one document are retrieved and analyzed and documents referred to by those documents are retrieved and analyzed and the retrieval and analysis are repeated recursively. Thus, an attempt is made to automatically traverse the entirety of the Web to catalog the entirety of the contents of the Web.

Due to the fact that documents of the Web are constantly being added and/or modified and also to the sheer immensity of the Web, no Web crawler has successfully cataloged the entirety of the Web. Accordingly, providers of Web content who wish to have their content included in search engine databases directly submit their content to providers of search engines. Other providers of content and/or services available through the Internet contract with operators of search engines to have their content regularly crawled and updated such that search results include current information. Some search engines, such as the search engine provided by Overture, Inc. of Pasadena, Calif. (http:/www.overture.com) and described in U.S. Pat. No. 6,269,361 which is incorporated herein by reference, allow providers of Internet content and/or services to compose and submit brief titles and descriptions, sometimes referred to as search listings, to be associated with their content and/or services and served as a result to a search query. As the Internet has grown and commercial activity has also grown over the Internet, some search engines have specialized in providing commercial search results presented separately from informational results with the added benefit of facilitating targeted advertising leading to increased commercial transactions over the Internet.

Since search engines which provide unwanted information are at a distinct disadvantage to search engines which minimize presentation of unwanted information, search engine providers have a strong interest in maximizing relevance of results provided to search queries.

What is needed is a system for assessing the performance of search listings in multiple contexts and markets and for automatically identifying and optimizing certain listings in order to improve performance of such listings.

### SUMMARY OF THE INVENTION

In accordance with the present invention, performance of a search listing within a search database is monitored to identify generally irrelevant and/or undesirable search listings for automatic optimization or removal. Performance is measured as a relationship between the manner in which the search listing is presented to the user and the frequency of selection of the search listing relative to either all other search listings and/or other search listings presented in a similar manner. For example, the rate at which a user selects a search listing from among a set of one or more search listings provides a measure of the pertinence of the search listing to the particular search terms of a search query.

According to the present invention, a search listing which is selected a significantly fewer number of times than expected is flagged as a possibly irrelevant and/or undesirable search listing and is evaluated for optimization and/or removal. Performance can be compared to expected performance at relative positions, sometimes referred to as ranks, within a set of search results. For example, a search listing can perform at an average level relative to all other search results but poorly for its position—such as a search listing which is presented first to the user yet has a selection rate which is much less than expected for a first-placed search listing and perhaps more comparable to a fourth-placed search listing. Such can indicate that the search listing makes an unfavorable impression upon users generally and perhaps could benefit from evaluation and optimization or should be removed completely as being irrelevant to that search query.

At least two different measurements of performance are used. One is absolute performance. Another is relative performance. Absolute performance measures the frequency of selection of a particular search listing compared to an expected frequency of selection of any search listing at a similar position within a set of search results of a given length. Relative performance measures the frequency of selection of a particular search listing within a set of search results relative to the frequency of selection of other search listings in the set in comparison to expected relative selection frequencies. Selection frequencies are sometimes referred to herein as click-through rates.

The expected relative selection frequencies are derived from past performance data both generally among all search listings served as results for all search queries and specifically among search listings pertaining to common products and/or services returned as similar results to the same query. In this manner, expected click-through rates include both a general expected click-through rate for each rank of search listing and a specific expected click-through rate for specific search listings returned as a result to a specific query.

Sometimes a search query is well-formed so as to retrieve relatively few highly relevant search listings. For example, a search query of “ucla sweatshirt” is relatively specific and is likely to retrieve search listings which are quite relevant. Accordingly, users seeing a short list of relevant search listings are likely to click through such search listings and the expected click-through rate is higher than average for all search listings served in response to this query.

Sometimes a search query is not well targeted and therefore is likely to retrieve a large number of search listings of relatively little relevance. For example, the search query “internet store” could retrieve search listings referring to nearly every e-commerce web site in existence. Accordingly, users seeing a long list of mostly irrelevant search listings are likely to pass over many search listings without clicking though, and the expected click-through rate is therefor lower than average for search listings served in response to that query. Thus, specific expected click-through rates improve performance evaluation according to the present invention.

To assure that performance measurements are statistically reliable, performance of a search listing is not evaluated until the search listings has had a minimum number of impressions. As used herein, an impression is a presentation of the search listing to a user as a result in response to a search query. An impression includes a context which in turn includes a size of the set of search results and a position at which the search listing was presented within the set.

The best minimum number of impressions varies according to the search volume of a particular search listing. If a low-volume search listing has too high a minimum number of impressions for performance evaluation, performance evaluation of the search list can be too infrequent and a poor search listing may be permitted to unduly harm the perceived value of the search engine. Conversely, if a high-volume search listing has too low a minimum number of impressions for performance evaluation, performance evaluation of the search listing can be too frequent, wasting processing resources and perhaps leading to frequent fluctuations in the perceived performance of the search listing. Accordingly, minimum number of impressions is dynamic and adjusts to the search volume of the search listing.

Impressions are filtered to assure that only legitimate searches are considered in assessing performance of search listings. Clicks are similarly filtered to assure that clicks represent only legitimate selections made by a human user. As used herein, a click is an act of selecting a search listing from among a set of search results by a user. In some search engines, clicking of a search listing by a human user is a billable event for which the search engine provider charges an agreed-upon amount to the owner of the clicked search listing.

To allow performance measurements to adapt to changes and to avoid undue influence of distant past performance over current performance measurements, performance can be limited to only the most recent impressions and clicks or dynamically adjusted to cover any combination of time period and serving locations. The best number of most recent impressions to consider also varies with the search volume of the particular search listing and the number of considered most recent impressions is therefore dynamic, adapting to the search volume of the particular search listing.

When a search listing is determined to be performing at a level below a minimum permissible level of performance, the search listing is marked for optimization or removal from the search database such that the search listing is either edited to improve performance or is no longer available as a result to that search query. As a result, search listings which give an unfavorable, or simply an unappealing, impression to users who submit search queries are automatically identified and improved or culled from the search database, thereby substantially increasing the value and function of the search engine. Doing so automatically makes monitoring and maintenance of particularly large search databases more manageable. In addition, search engine providers can dynamically improve the overall performance of their search engine by monitoring the performance of individual search listings.

Once a search listing is marked as under-performing, the search listing can be handled in any of a number of ways. One way is to leave the search listing active in the search database pending modification of the search listing. Another way is to remove the listing pending modifications and to thereafter re-include the search listing into the search database. Modifications to under-performing search listings can also be made manually by human editors or automatically. For example, performance data shows that search listings which contain the search query in their title perform better than search listings whose title does not contain the exact search query. Absence of the search query itself can be automatically detected and the search listing itself can be automatically modified such that the title includes the search query.

Another form of automatic modification is the demotion of a search listing from one type of applicable search to another. Demoting the search listing from one type to another reduces the search queries which match the search term of the search listing. Such ensures a better fit between the search listing and the search query and improves the likely performance of the search listing, giving the search listing a chance for improved performance prior to removal of the search listing.

### BRIEF DESCRIPTION OF THE DRAWINGS

FIG. 1 is a block diagram showing host computers, client computers, and a search engine according to the present invention coupled to one another the a wide area network.

FIG. 2 is a block diagram showing the search engine in greater detail.

FIG. 3 is a logic flow diagram showing performance monitoring by the search engine in accordance with the present invention.

FIG. 4 is a block diagram showing a search server of the search engine of FIG. 2 in greater detail.

FIG. 5 is a logic flow diagram showing a manner in which user selection of search listings is detected.

FIG. 6 is a state diagram illustrating various states of search listing during performance monitoring in accordance with the present invention.

FIG. 7 is a logic flow diagram showing the preparation of a number of search listings presented as results of a search for performance evaluation in accordance of the present invention.

FIG. 8 is a logic flow diagram showing collection of information regarding impressions and selection of search listings in accordance with the present invention.

FIG. 9 is a block diagram of a performance database used to evaluate performance of search listings in accordance with the present invention.

FIG. 10 is a block diagram of a search file of the performance database of FIG. 9 in greater detail.

FIG. 11 is a block diagram of a bid click file of the performance database of FIG. 9 in greater detail.

FIG. 12 is a block diagram of the performance monitor of the search engine of FIG. 2 in greater detail.

FIG. 13 is a logic flow diagram of the evaluation of performance of a number of search listings in accordance with the present invention.

FIGS. 14, 15, and 16 are each a logic flow diagram showing a respective portion of the logic flow diagram of FIG. 13 in greater detail.

### DETAILED DESCRIPTION

In accordance with the present invention, unusually poorly performing search listings in a search database are automatically flagged for demotion or removal and for evaluation. Unusually poor performance of a search listing is a strong indicator that the search listing is giving an undesirable impression to users of the search database. Automatically flagging such search listings enables ferreting out of undesirable search listings which may have eluded any editorial filtering mechanism to avoid inclusion of such search listings in the search database. Demotion allows a tighter fit between the search listing and search queries to which the search listing is responsive—increasing the likely performance of the search listing. Parameters of the performance evaluation are dynamic and adjust to the search volume of individual search listings to provide more effective evaluation of the performance of the search listings.

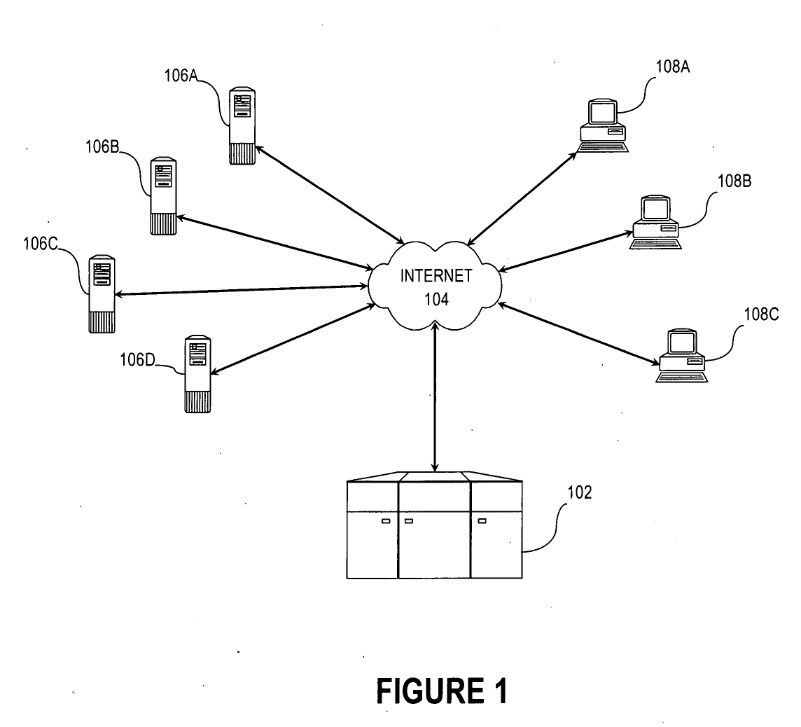

FIG. 1 shows a search engine 102 which is coupled to, and serves, a wide area network 104 which is the Internet in this illustrative embodiment. A number of host computer systems 106A-D are coupled to Internet 104 and provide content to a number of client computer systems 108A-C. Of course, FIG. 1 is greatly simplified for illustration purposes. For example, while only four (4) host computer systems and three (3) client computer systems are shown, it should be appreciated that (i) host computer systems and client computer systems coupled to the Internet collectively number in the millions of computer systems and (ii) host computer systems can retrieve information like a client computer system and client computer systems can host information like a host computer system.

Search engine 102 is a computer system which catalogs information hosted by host computer systems 106A-D and serves search requests of client computer systems 108A-C for information which may be hosted by any of host computers 106A-D. In response to such requests, search engine 102 produces a report of any cataloged information which matches one or more search terms specified in the search request. Such information, as hosted by host computer systems 106A-D, includes information in the form of what are commonly referred to as web sites. Such information is retrieved through the known and widely used hypertext transport protocol (HTTP) in a portion of the Internet widely known as the World Wide Web. A single multimedia document presented to a user is generally referred to as a web page and inter-related web pages under the control of a single person, group, or organization are generally referred to collectively as a web site. While searching for pertinent web pages and web sites is described herein, it should be appreciated that some of the techniques described herein are equally applicable to search for information in other forms stored in a wide area network.

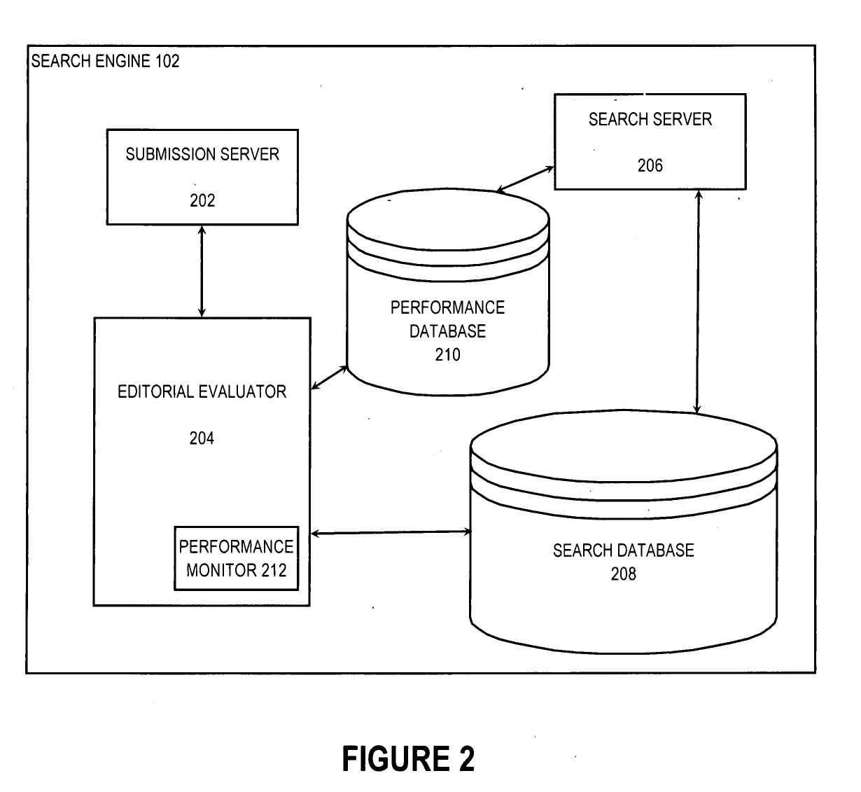

Search engine 102 is shown in greater detail in FIG. 2. Search engine 102 includes a search server 206 which receives and serves search requests from any of client computer systems 108A-C using a search database 208. Search engine 102 also includes a submission server 202 for receiving search listing submissions from any of host computers 108A-D. Each submission requests that information hosted by any of host computers 108A-D be cataloged within search database 208 and therefore available as search results through search server 206.

To avoid providing unwanted search results to client computer systems 108A-C, search engine 102 includes an editorial evaluator 204 which evaluates submitted search listings prior to inclusion of such search listings in search database 208.

In this illustrative embodiment, search engine 102—and each of submission server 202, editorial evaluator 204, and search server 206—is all or part of one or more computer processes executing in one or more computers. Briefly, submission server 202 receives requests to list information within search database 208, and editorial evaluator 204 evaluates submitted search listings prior to including them in search database 208. The process by which such search listings are evaluated is described more completely in U.S. patent application Ser. No. 10/244,051 filed Sep. 13, 2002 by Dominic Cheung et al. and entitled “Automated Processing of Appropriateness Determination of Content for Search Listings in Wide Area Network Searches” and that description is incorporated herein by reference for any and all purposes.

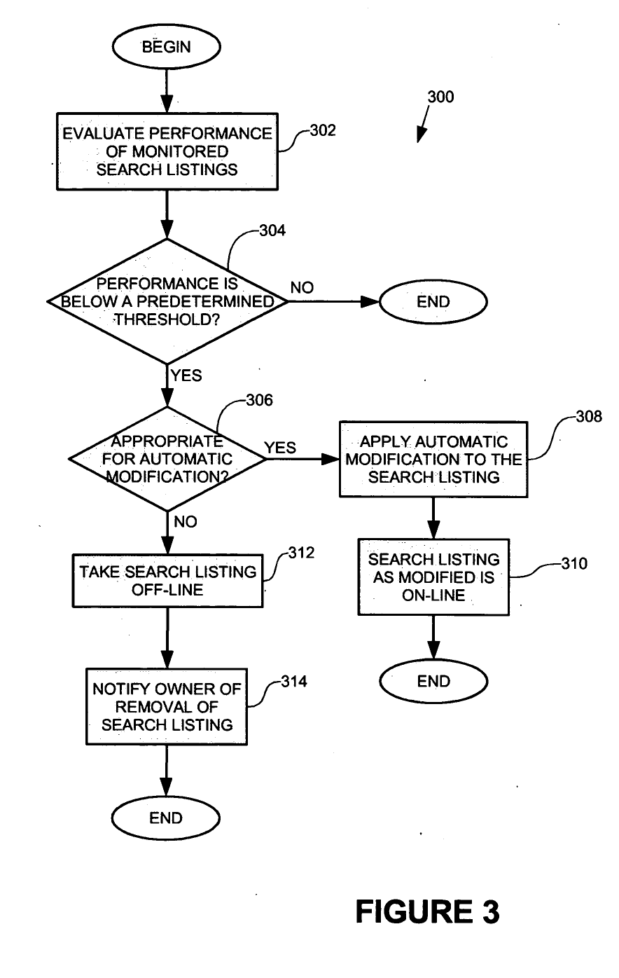

Search engine 102 also includes a performance database 210 which includes data which tracks performance of individual search listings in accordance with the present invention. Editorial evaluator 204 includes a performance monitor 212 which uses performance database 210 to evaluate search listing performance to determine which, if any, search listings should be removed from search database 208. The behavior of performance monitor 212 is described briefly here in the context of logic flow diagram 300 (FIG. 3) and in greater detail further below.

In step 302, performance monitor 212 (FIG. 2) periodically evaluates performance of monitored search listings. In this illustrative embodiment, performance of a search listing is updated each time the search listing is served as a result to a search, thereby ensuring that performance evaluation of the search listing is always current. In an alternative embodiment, search listing performance is evaluated periodically, e.g., daily.

Only search listings which are automatically approved without human editorial oversight are marked for performance monitoring in this illustrative embodiment. Furthermore, some submitters are deemed trustworthy and their search listings are generally not monitored for performance. However, in an alternative embodiment, all search listings are monitored for performance. In this embodiment, periodic performance evaluation of search listings is done monthly. In alternative embodiments, such evaluation is done weekly and semi-monthly, respectively. Of course, other periods for evaluation can be used. It is preferred that the frequency of performance evaluation be such that (i) enough performance data can be collected to provide a fairly reliable assessment of relative performance and (ii) enough data can be collected between assessments that the assessment can realistically be expected to change by a significant and measurable amount.

The manner in which performance monitor 212 evaluates performance of the various search listings is described below. In test step 304 (FIG. 3), performance monitor 212 (FIG. 2) determines whether the assessed performance is below a predetermined threshold. The predetermined threshold is described below in conjunction with a more detailed description of the evaluation of search listing performance. If the performance is not below the predetermined threshold, performance monitor 212 determines that the search listing is not particularly undesirable and processing according to logic flow diagram 300 (FIG. 3) completes, leaving the search listing in search database 208 (FIG. 2).

Conversely, if the performance of the search listing is below the predetermined threshold, performance monitor 212 determines that the search listing is unusually undesirable and processing transfers to test step 306 (FIG. 3). In test step 306, performance monitor 212 determines whether the search listing is a candidate for automatic modification. Performance monitor 212 maintains a number of search listing modification profiles which are believed to improve performance of a search listing. One such profile indicates that including a search query for which the search listing is particularly appropriate in the title of the search listing. In this illustrative example, performance monitor 212 makes the determination of test step 306 by determining whether the title of the search listing already includes the search query.

If the search listing is a candidate for automatic modification, processing transfers from test step 306 to step 308 in which performance monitor 212 applies one or more automatic modification profiles to the search listing. In this illustrative example, performance monitor 212 modifies the title of the search listing to include the search query. A more elaborate type of automated modification in accordance with an alternative embodiment is described below in the context of logic flow diagram 308A (FIG. 18). In step 310, the modified search listing put on-line, i.e., is stored within search database 208 in such a way that the search listing, as modified, is available to be served as a result to search queries. After step 310, processing according to logic flow diagram 300 completes.

If performance monitor 212 (FIG. 2) determines in test step 306 (FIG. 3) that the search listing is not a candidate for automatic modification, processing transfers to step 312. In step 312, performance monitor 212 (FIG. 2) takes the search listing off-line. In one embodiment, performance monitor 212 takes the search listing off-line by removing the search listing from search database 208. In an alternative embodiment, performance monitor 212 takes the search listing off-line by marking the search listing as unavailable and leaving the search listing so marked in search database 208. In this alternative embodiment, search server 206 only provides, as search results, search listings of search database 208 which are not marked as unavailable.

In step 314 (FIG. 3), performance monitor 212 (FIG. 2) notifies the owner of the off-line search listing regarding the off-line status of the search listing. Accordingly, the owner is able to take corrective action, e.g., submitting a new search listing which is more likely to be acceptable to users of search server 206.

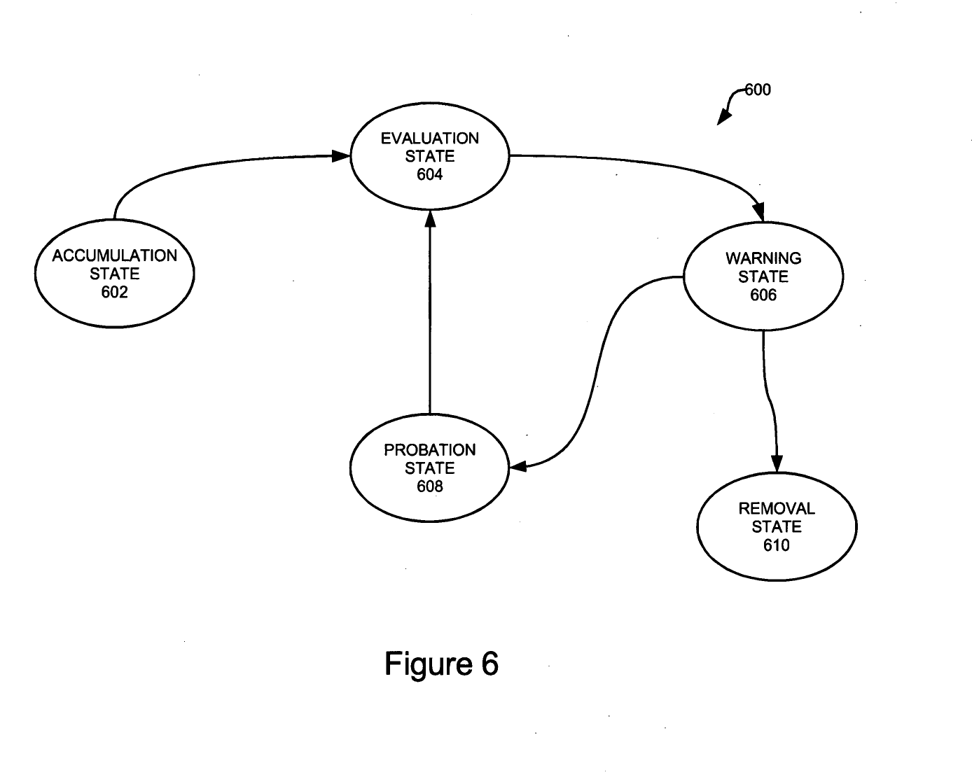

State diagram 600 (FIG. 6) illustrates a more complex embodiment in which under-performing search listings are not removed—e.g., in step 312 (FIG. 3) either immediately or after automatic modification in step 308 and subsequent continued under-performance—but, instead, owners of under-performing search listings are provided with an opportunity to improve their search listings prior to removal.

When a search listing is first approved for inclusion in search database 208 (FIG. 2), that search listing is in accumulation state 602 (FIG. 6). In accumulation state 602, data regarding performance of the search listing is accumulated in a manner described more completely below. A search listing in accumulation state 602 is not evaluated in terms of performance of the search listing until the search listing has accumulated a predetermined number of impressions, i.e., a predetermined number of times that the search listing has been presented to the user as a result of a search. In this illustrative embodiment, the predetermined number of impressions is 200 impressions. Of course, other values can be used for the predetermined number of impressions. In one preferred embodiment, the predetermined number of impressions is dynamic and adjusts according to the specific search volume of each search listing in a manner described more completely below.

Once the search listing has accumulated the predetermined number of impressions, the search listing enters evaluation state 604. Evaluation state 604 is the state that most search listings remain in for the majority of the time. In evaluation state 604, the performance of the search listing is evaluated in the manner described more completely herein. As long as the performance of the search listing remains above the predetermined threshold, the search listing remains in evaluation state 604. However, if the performance of the search listing ever falls below the predetermined threshold, the search listing enters warning state 606.

In warning state 606, the owner of the under-performing search listing is notified of the poor performance of the search listing and is provided with a limited amount of time to modify the search listing. Alternatively, rather than providing the owner with an opportunity to modify the search listing, the search listing can be automatically modified if automatic modification is determined to be appropriate as described above with respect to steps 306-310 (FIG. 3).

Notification to the owner, either of the need to modify or of the automatic modification, can be by e-mail or can also be in the form of notices presented to the owner within a web-based account management application by which the owner is provided access to search listings owned and such a web-based application is described more completely below with respect to FIG. 17. Such access can include, for example, statistics of search listing performance, attributes of search listings, and accounting information. The notification can also include suggestions regarding ways to improve performance of the search listing.

If the owner modifies the under-performing search listing within the predetermined period of time, e.g., fourteen days, the search listing enters a probation state 608. Conversely, if the search listing is not modified within the predetermined period of time, the search listing enters a removal state 610 in which the search listing is removed from search database 208 (FIG. 2) and the owner of the search listing is notified of the removal.

In probation state 608, data regarding performance of the search listing is accumulated in a manner similar to that of accumulation state 602. A search listing in probation state 608 is not evaluated in terms of performance of the search listing until the search listing has accumulated a predetermined number of impressions. In this illustrative embodiment, the predetermined number of impressions is 200 impressions. Once a search listing in probation state 608 has accumulated the predetermined minimum number of impressions, the search listing returns to evaluation state 604 and evaluation of the search listing continues.

In some embodiments, accumulation state 602 and probation state 608 are the same state. In alternative embodiments, probation state 608 differs from accumulation state 602. Exemplary differences between accumulation state 602 and probation state 608 include differences in the predetermined number of impressions to accumulate before transitioning to evaluation state 604 and maintenance of records of previous times that the search listing was in probation state 608. This latter difference is useful in limiting the number of times a particular search listing can be permitted to enter probation state 608. For example, search listings can be limited to one automatic modification and three probation states before being removed without providing the owner with an opportunity to modify the search listing again.

To facilitate assessment of performance of various search listings, search server 206 collects data regarding the impressions of search listings and clicks of search listings. Impressions of a search listing refers to the manner in which the search listing is presented as a result of searches. Clicks refer to selection of the search listing by a user to thereby retrieve and view the web page or other information represented by the search listing.

In this illustrative embodiment, an impression of a search listing is defined by the search to which the listing is supplied as a result and the display position within the results of the search. Further in this illustrative embodiment, the impression includes data specifying whether the search listing is bid, i.e., whether the owner of the search listing has paid for prominent placement of the search listing. As an example, an impression of a search listing can be defined by data specifying that the search listing is the third bid search listing supplied as a search result for the search defined by the terms “experimental aircraft engine.”

Since the raison d'etre of a search engine is to facilitate location of desired information throughout wide area networks such as Internet 104, an indication of successful location of desirable information is the attempted retrieval of the information associated with a result search. listing presented to the user. In simple terms, the user is presented with a link to the web page associated with a search listing and activates the link, e.g., by “clicking” on the link using a mouse or other conventional user input device, thereby requesting the web page associated with the search listing. Thus, a “click” of a search listing refers to activation of the link associated with the search listing by the user, and a “click” is an indication that the search listing provides desirable information to the user.

Generally, certain places within a list of search results are better than other places. In other words, users are generally more likely to click on search results presented in such places within the search results relative to search results at other places. Accordingly, in one embodiment, performance of a search listing is evaluated by comparison of the rate at which the search listing is clicked relative to other search listings at similar positions within search results as presented to users. Thus, information is gathered regarding the various positions of search listings presented to the user and the clicking of such search listings by users.

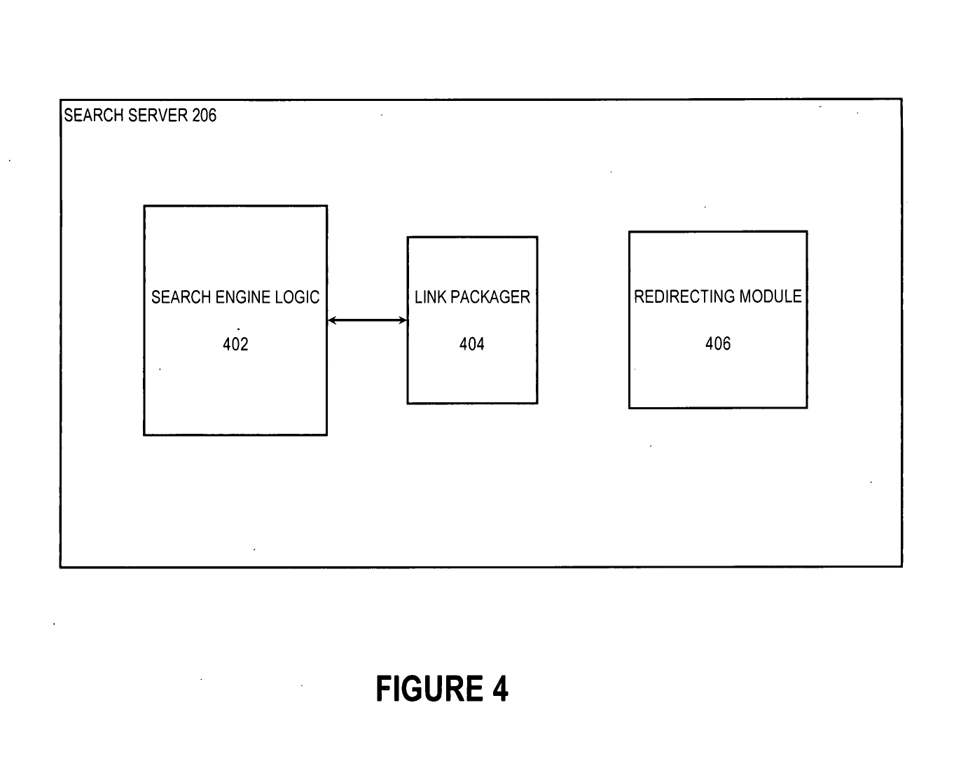

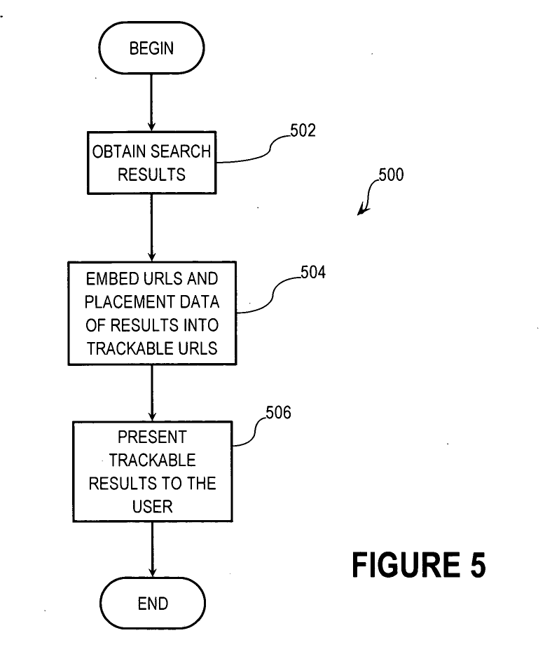

To gather data representing impressions and clicks, search server 206 includes a link packager 404 (FIG. 4) and a redirecting module 406. Search server 206 also includes search engine logic 402 which is conventional except as described otherwise herein. Behavior of search server 206 in response to receiving a search request which includes one or more search terms from any of client computer systems 108A-D (FIG. 1) is illustrated by logic flow diagram 500 (FIG. 5).

In step 502, search engine logic 402 (FIG. 4) obtains, from search database 208 (FIG. 2), a number of search listings generally most relevant to the search terms and in accordance with bid amounts associated with the various search listings stored in search database 208.

In step 504 (FIG. 5), search engine logic 402 (FIG. 4) passes the search listings obtained in step 502 to link packager 404. For each search listing, link packager 404 parses the URL of the search listing and encodes both the URL and data representing an impression of the search listing. The encoded URL and impression data are included in a new URL which is addressed to redirecting module 406. Thus, link packager 404 maintains data representing impressions as search results are presented to users and encodes data which is subsequently received and parsed by redirecting module 406 to obtain data representing clicks. The receipt and parsing by redirecting module 406 is described more completely below. Link packager 404 presents the encoded URLs to search engine logic 402 which then presents the encoded URLs to the user as part of the search results in step 506.

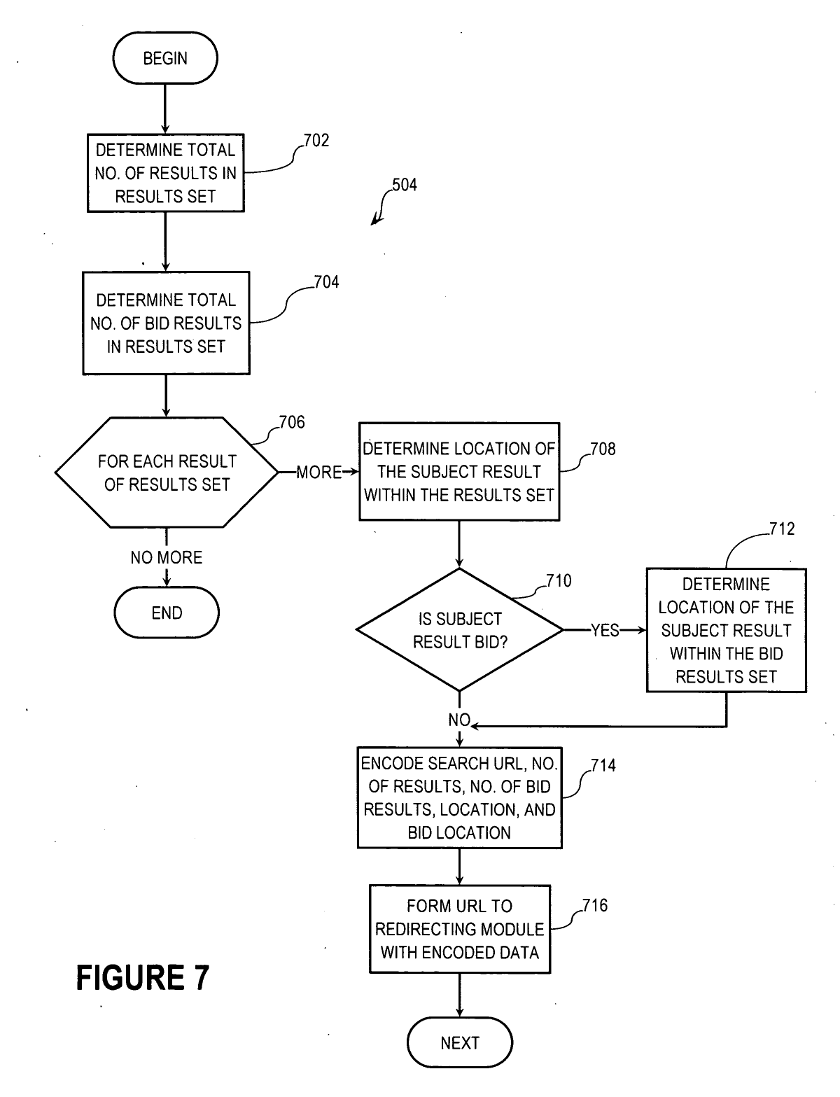

Step 504 as performed by link packager 404 (FIG. 4) is shown in greater detail as logic flow diagram 504 (FIG. 7). In step 702, link packager 404 (FIG. 4) determines the total number of result search listings which are included in the set of results for the currently served search request. In step 704 (FIG. 7), link packager 404 (FIG. 4) determines the total number of bid search listings included in the set of search results. In one embodiment, the total number of search listings and the total number of bid search listings included in a set of search results is predetermined by search engine logic 402 and communicated to link packager 404. In an alternative embodiment, search engine logic 402 communicates the set of resulting search listings to link packager 404 and link packager 404 infers the numbers of total and bid search listings by examining the search listings themselves.

Loop step 706 and next step 718 define a loop in which link packager 404 (FIG. 4) processes each search listing of the set of results according to steps 708-716 (FIG. 7). During a particular iteration of the loop of steps 706-718, the particular search listing processed is referred to as the subject search listing.

In step 708, link packager 404 (FIG. 4) determines the location of the subject search listing within the set of results. In one embodiment, the relative position within the list is specified by search engine logic 402 according to the relative relevance and/or the relative bid amounts of each search listing of the set of results and those relative positions are communicated to link packager 404 by search engine 402 by sending data explicitly specifying those positions. In an alternative embodiment, the relative position determined by search engine 402 is inferred from the order in which search listings are communicated to link packager 404.

In test step 710 (FIG. 7), link packager 404 (FIG. 4) determines whether the subject search listing is bid. For example, link packager 404 can read data received from search engine logic 402 which explicitly indicates whether each search listing is bid. Alternatively, whether a search listing is bid can be inferred from the relative position of each search listing within the set of results. In an illustrative embodiment, the first three and last two search listings of the set of results are bid and the remaining search listings are unbid.

If the subject search listing is bid, processing transfers to step 712 (FIG. 7) in which link packager 404 (FIG. 4) determines the relative position of the subject search listing within the set of bid search results. In the manner described above, this relative position can be explicitly stated or inferred from the set of search listing results. Conversely, if the subject search listing is unbid, link packager 404 skips step 712 (FIG. 7).

In step 714, link packager 404 (FIG. 4) encodes the total number of search listings, total number of bid search listings, URL of the subject search listing, and the relative locations within all search results and within all bid search results of the subject search listing. These values can be encoded as cleartext CGI variables or can be encoded as a hash or other cryptographic scrambling of the data to conceal the specific values encoded and to thereby thwart tampering of such values.

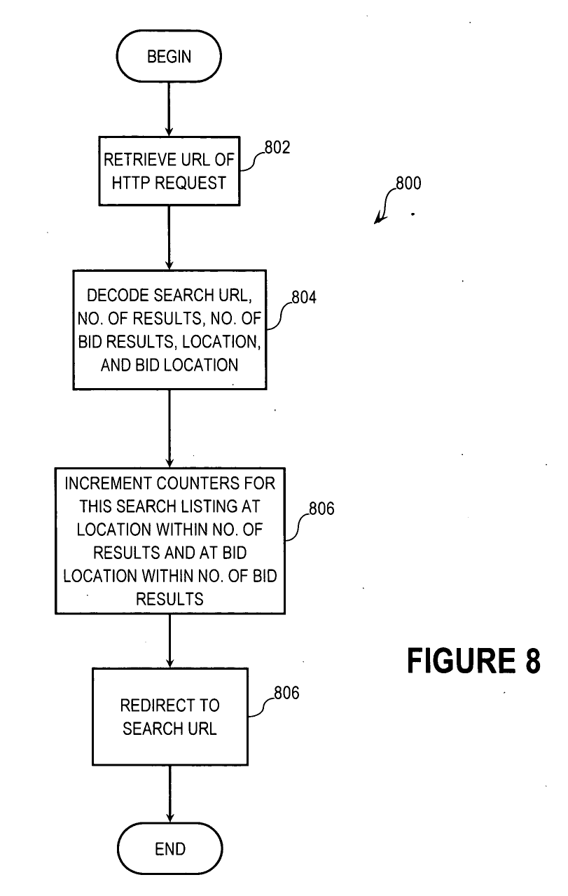

In step 716 (FIG. 7), link packager 404 (FIG. 4) forms a trackable URL which includes the encoded data from step 714 (FIG. 7). The URL is trackable because it is addressed to redirecting module 406 (FIG. 4). Thus, after presentation of the search listings to the user at any of client computers 108A-D (FIG. 1), any selection of any search listing by the user sends an HTTP request to redirecting module 406 (FIG. 4). Redirecting module 406 is therefore in a position to intercept clicked search listings and record such clicking activity as illustrated in logic flow diagram 800 (FIG. 8).

In step 802, redirecting module 406 (FIG. 4) retrieves the URL of the HTTP request. As described above, the URL includes data representing the total number of search listings presented to the user, the total number of bid search listings presented to the user, the URL of the user-selected search listing, and the relative positions of the user-selected search listing within all search listings and within all bid search listings. Redirecting module 406 decodes these values from the URL in step 804 (FIG. 8).

In step 806, redirecting module 406 (FIG. 4) records the click represented by the retrieved URL for later performance evaluation in a manner described below. Briefly, redirecting module 406 records the specific search listing selected by the user and the search result set from which the search listing is selected along with a date and time stamp for filtering of clicks in a manner described more completely below.

In step 806, redirecting module 406 redirects the HTTP request to the address represented in the URL decoded from the retrieved URL in step 804. Thus, the user is eventually provided with the web page addressed by the URL of the selected search listing, and this is the behavior expected by the user.

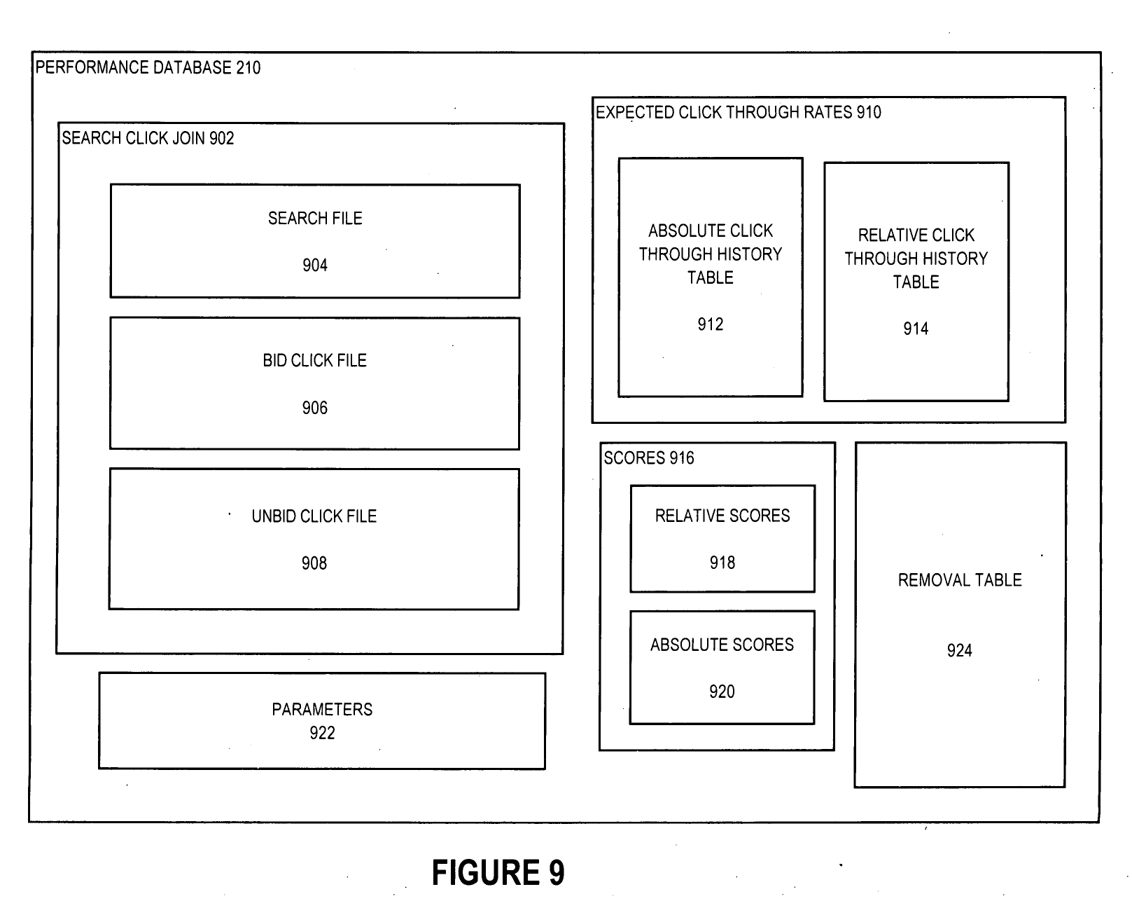

Searches, impressions, and clicks are represented in performance database 210 (FIG. 2) as described above. Performance database 210 is shown in greater detail in FIG. 9.

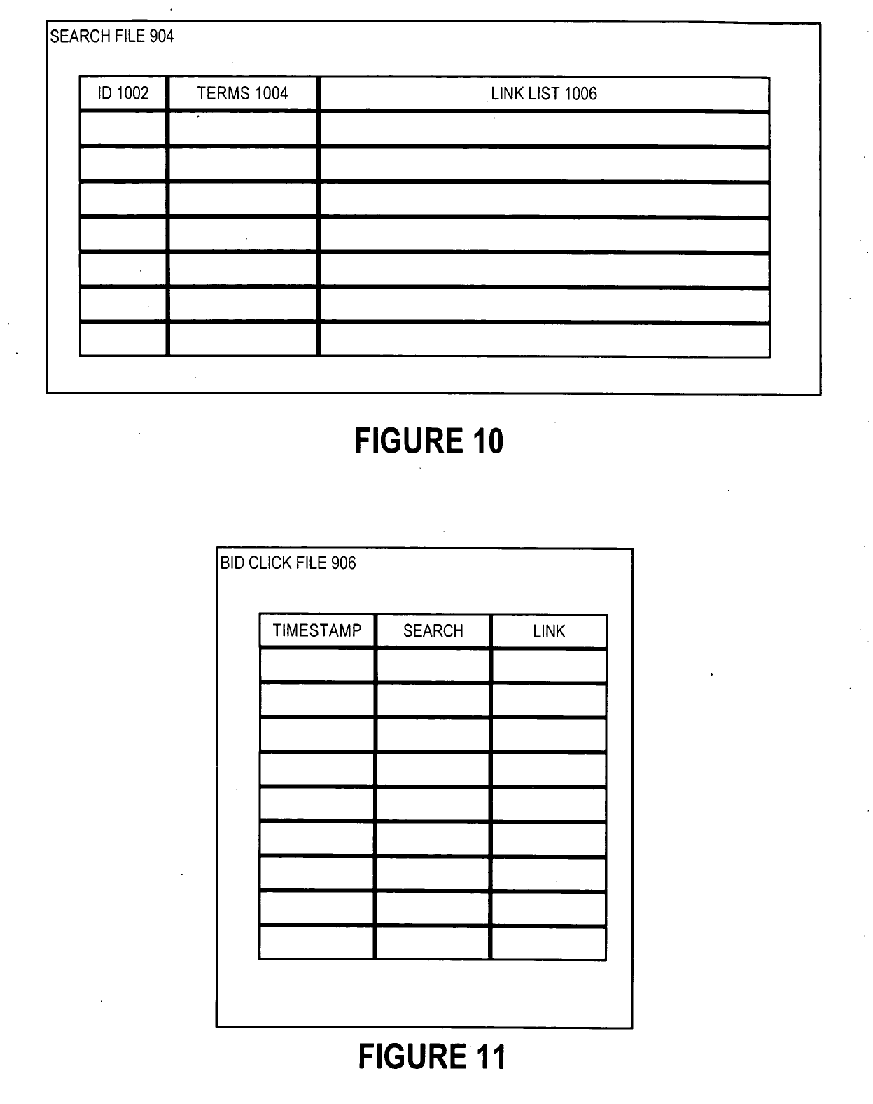

Performance database 210 includes a search click join 902 which in turn includes a search file 904, a bid click file 906, and an unbid click file 908. Search file 904 is shown in greater detail in FIG. 10.

Search file 904 includes a number of search records, each of which represents an individual search of search database 208 (FIG. 2). Identifier 1002 uniquely identifies a particular search. Terms 1004 represent the one or more search terms supplied by the user in the search identified by identifier 1002. Link list 1006 represents the search listings included in the set of results collected by search engine logic 402 (FIG. 4) and includes, for each search listing of the result set, an identifier by which the search listing can be located within search database 208 (FIG. 2), whether the search listing is bid or unbid, and the relative position within the set of all search listings and within the set of bid search listings if the search listing is bid. Whether the search listing is bid can be explicitly represented within link list 1006 or can be determined by retrieval of data from search database 208 representing the search listing.

A search record of search file 904 can represent a single set of search results sent one time to a specific individual user or can represent numerous searches in which the search terms as represented by terms 1004 and the set of result search listings as represented by link list 1006 are the same. Similarly, a set of results can be considered a set of search listings sent to the user in a single transaction for a single, unified representation of search listings (i.e., a single page of results) or, alternatively, can be considered a larger set of search listings spanning multiple pages and sent to the user in batches.

Bid click file 906 and unbid click file 908 are analogous to one another and the following description of bid click file 906 is equally applicable to unbid click file 908 except where otherwise noted. Primarily, bid click file 906 represents clicks of bid search listings whereas unbid click file 908 represents clicks of unbid search listings. Bid click file 906 is shown in greater detail in FIG. 11.

Bid click file 906 includes a number of click records, each of which represents a click, i.e., a selection by a user of a result search listing trapped by redirecting module 406 in the manner described above. Each click record includes a timestamp 1102, a search identifier 1104, and a link identifier 1106. Timestamp 1102 represents the date and time at which the click was detected by redirecting module 406. Timestamp 1102 is used for click filtering as described more completely below.

Search identifier 1104 specifies an individual search to which the click pertains and corresponds to a respective one of identifiers 1002 (FIG. 10) to thereby specify the associated search record. Accordingly, search identifier 1104 specifies a set of search listing results, e.g., link list 1006, from which the user has made a selection. Link identifier 1106 identifies the search listing selected by the user, i.e., identifies a specific search listing within link list 1006 as the one selected by the user.

Thus, search click join 902 (FIG. 9) records impressions and clicks of specific search listings in result sets of specific searches. Expected clickthrough rates 910 includes additional historical data for use in assessing performance of specific search listings of search database 208. Specifically, expected click through rates 910 includes absolute click through history table 912 and relative click through history table 914.

Tables 912-914 are used in a manner described more completely below in quantifying performance of specific search listings. Absolute click through history table 912 records the number of times search listings at each position are clicked in results sets of various sizes. For example, absolute click through history table 912 records the number of results sets that included only a single search listing and the number of times that single search listing was clicked. In addition, absolute click through history table 912 records the number of results sets that included two search listings and the number of times the first and second search listings were respectively clicked. Similarly, absolute click through history table 912 records the number of results sets that included three search listings and the number of times the first, second, and third search listings were respectively clicked. Absolute click through history table 912 records similar information for results sets which included search listings numbering four, five, and so on up to a predetermined maximum.

Relative click through history table 914 records similar information except that it records multiple search listings clicked in the same search. For example, relative click through history table 914 records, for results sets include two search listings, the number of times the first and second search listings were both clicked. Similarly, relative click through history table 914 records, for results sets include three search listings, the number of times the (i) first and second, (ii) second and third, and (iii) first and third search listings were both clicked. Clicks are similarly tallied for similar combinations in results sets including search listings numbering four, five, and so on up to a predetermined maximum.

It should be noted that all click histories for all searches, regardless of search terms or specific users, are included in absolute click through history table 912 and relative click through history table 914. The purpose of tables 912-914 is to provide an estimate of the likelihood that a search listing at a particular position within a set of results of a specific length is to be clicked regardless of content of the search listing. Thus, performance monitor 212 has a point of reference with which to identify under-performing search listings.

Scores 916 represent relative performance of individual search listings as determined by performance monitor 212 in the manner described below. Removal table 924 identifies individual search listing which have been determined by performance monitor 212 as under-performing and therefore destined for modification and/or removal from search database 208. Parameters 922 include data controlling the assessment of performance by performance monitor 212 in the manner described below.

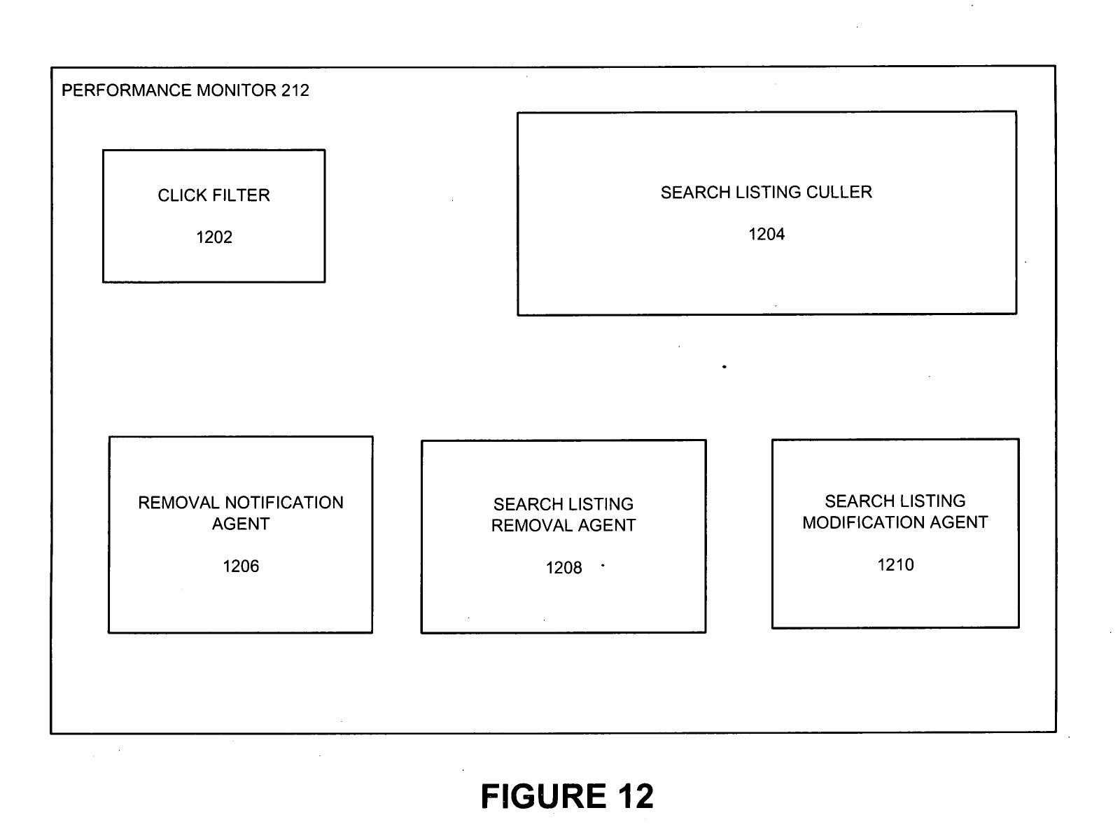

Thus, with performance data gathered by redirecting module 406 in cooperation with link packager 404, performance monitor 212 is in a position to effectively assess performance of specific search listings. Performance monitor 212 is shown in greater detail in FIG. 12.

Performance monitor 212 includes a click filter 1202 which removes data representing user selections which may improperly influence performance assessment of a search listing. For example, when user selections of search listings appear so close together in time as to be unlikely the product of selection by a human user, it is presumed that a user has inadvertently clicked the same link multiple times in a single selection or that a computer process is emulating a human user and making selections faster than a human probably would. In either case, search listing selections which follow another from the same client computer system, e.g., any of client computer systems 108A-D, by less than a predetermined threshold time are discarded by click filter 1202. The predetermined time threshold is represented in parameters 922 (FIG. 9).

Click filter 1202 (FIG. 12) also discards clicks which correspond to searches following similar searches too closely in time. In this illustrative embodiment, the threshold closeness between searches for discarding search records is a predetermined portion of an average inter-search interval taken over a predetermined number of searches for the same search term. The predetermined portion and predetermined number of searches are represented in parameters 922 (FIG. 9).

Other types of clicks do not represent clicks of human users in the context of an honest search for content of the Web. Examples of such clicks include clicks pertaining to a search in which an owner of a search listing submits search queries to determine how that search listing is placed among other search listings pertaining to the same search query and an owner of a search listing searching for the search listing in an attempt to improperly inflate the evaluated performance of the search listing. Click filter 1202 removes all illegitimate searches in the manner described more completely in U.S. patent application Ser. No. 10/429,209 filed on May 2, 2003 by Scott B. Kline et al. and entitled “Detection of Improper Search Queries fin a Wide Area Network Search Engine” and that description is incorporated herein by reference. In removing illegitimate searches, click filter 1202 also removes any clicks associated with those removed searches. In addition to filtering searches, click filter 1202 can detect invalid clicks in the manner described in U.S. patent application Ser. No. 09/765,802 by Stephan Doliov entitled “System and Method to Determine the Validity of an Interaction on a Network” and that description is incorporated herein by reference. Any detected invalid clicks are removed. Filtering of clicks is particularly important in shallow search term markets, i.e., in the context of search terms which are relatively infrequently searched. Due to the relative infrequency of searching for those terms, improper searches in shallow markets are more likely to appreciably affect the measured performance of search listings.

In one embodiment, click filter 1202 (FIG. 12) filters clicks and searches as they are accumulated in search click join 902 (FIG. 9). Accordingly, search click join 902 stores data representing only legitimate clicks and searches. In an alternative embodiment, all clicks and searches are recorded in search click join 902 and click filter 1202 (FIG. 12) filters search and clicks as they are imported by performance monitor 212 for processing.

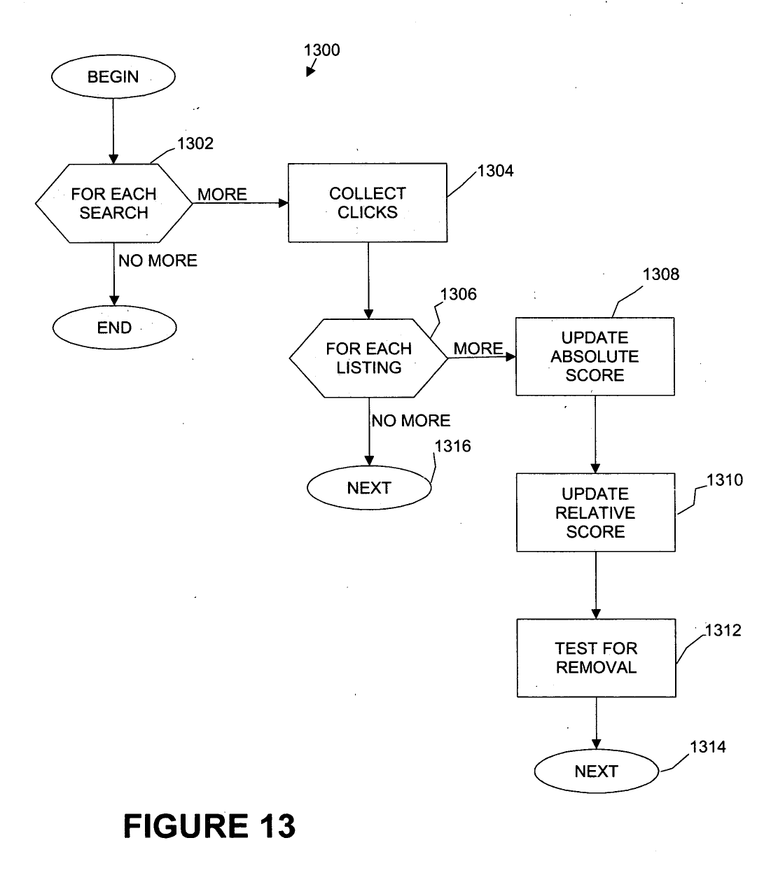

Performance monitor 212 includes a search listing culler 1204 which assesses the performance of search listings to determine if any are under performing by a sufficient margin to warrant removal of the search listing. Such is illustrated by logic flow diagram 1300 (FIG. 13).

In this illustrative embodiment, processing according to logic flow diagram 1300 is performed monthly. Such provides an opportunity for search listings to be included in results sets for a sufficient number of searches to provide reasonably reliable statistical analysis. Of course, others frequencies can be used such as quarterly, bimonthly, semi-monthly, weekly, or even daily for particularly active search listings. In a preferred embodiment, processing according to logic flow diagram 1300 is performed for each impression of a particular search listing so long as the impression is at least a predetermined gap in time from the prior performance of logic flow diagram 1300. The predetermined gap is dynamic and adjusts to the particular search volume of the search listing in a manner described more completely below.

Loop step 1302 and next step 1316 define a loop in which search listing culler 1204 processes each search stored in search file 904 (FIG. 9) according to steps 1304-1314. During each iteration of the loop of steps 1302-1316, the particular search processed by search listing culler is sometimes referred to as the subject search.

In step 1304, search listing culler 1204 (FIG. 12) collects click records from bid click file 906 (FIG. 9) and unbid click file 908 which pertain to the subject search. Such click records are those whose search field 1104 (FIG. 11) identifies the subject search. The result is a set of links from link field 1106 within link list 1006 (FIG. 10) that were selected by the user having seen the set of results returned for the subject search.

Loop step 1306 and next step 1314 define a loop in which search listing culler 1204 processes each search listing of link list 1006 (FIG. 10) of the subject search according to steps 1308-1312. During each iteration of the loop of steps 1306-1314, the particular search listing processed by search listing culler 1204 is sometimes referred to as the subject search listing in the context of FIG. 13.

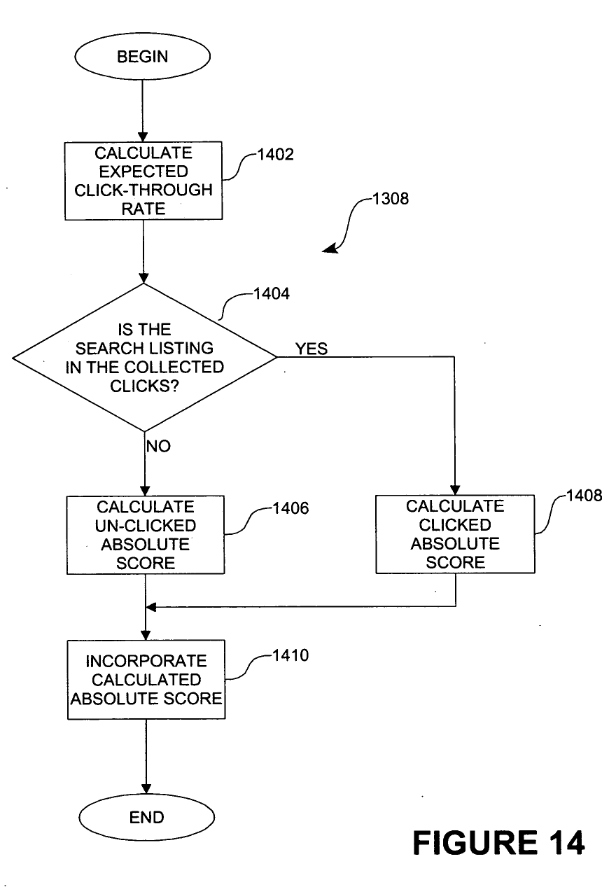

In step 1308, search listing culler 1203 updates the absolute score of the subject search listing. Step 1308 is shown in greater detail as logic flow diagram 1308 (FIG. 14). In step 1402, search listing culler 1203 determines the expected click-through rate for a search listing in the position of the subject search listing within a search result set the size of link list 1006 (FIG. 10) of the subject search. For example, if the subject search listing is the third search listing of the subject search's result set and the subject search yielded ten resulting search listings, search list culler 1204 (FIG. 12) determines the expected click-through rate for a third-position search listing in a set of ten search listings in step 1402 (FIG. 14).

Search listing culler 1204 (FIG. 12) makes such a determination from absolute click through history table 912 which stores (i) the total number of searches in search file 904 of each respective length and (ii) for each length of search, the number of times a search listing at each respective position was clicked. The expected click-through rate for each position is therefore the number of times the search listing at the position in question was clicked divided by the number of times a search result set of the length in question was presented to a user.

In some embodiments, all impressions of the subject search listing are considered when evaluating performance of the search listing. However, in this illustrative embodiment, only a limited number, e.g., two hundred, of the most recent impressions are considered. In an alternative embodiment, the limited number of most recent impressions is dynamic and adjusts according to the search volume of the particular search listing in a manner described below in greater detail. By considering only recent impressions, recent performance is evaluated. Accordingly, changes in performance after a very large number of impressions can be detected despite a very long history of impressions which might otherwise unduly influence recent performance evaluation.

In test step 1404, search listing culler 1204 determines whether the subject search listing is included in the set of clicks collected in step 1304. If so, processing transfers to step 1408 in which search listing culler 1204 calculates a clicked absolute score for the subject listing. Conversely, if the subject search listing is not included in the set of collected clicks, processing transfers to step 1406 in which search listing culler 1204 calculates an un-clicked absolute score for the subject search listing.

A clicked absolute score in this illustrative embodiment is the difference of two less the expected click through rate. An un-clicked absolute score in this illustrative embodiment is the difference of one less the expected click through rate. A search listing which is generally expected to be clicked but is not clicked has a low absolute score—approaching zero. A search listing which is generally not expected to be clicked and is not clicked has an absolute score less than, but approaching one. A search listing which is generally expected to be clicked and is clicked has an absolute score above, but close to one. A search listing which is generally not expected to be clicked and is clicked has the highest score—approaching two. Thus, the absolute score measures a relation between whether the search listing is selected by the user relative to the expectation that the user would select the search listing as a result of its position in the result set. Of course, the absolute score can be scaled as desired. In this illustrative embodiment, the absolute score is scaled by 50 such that absolute scores range from zero to one hundred.

After either step 1406 or step 1408, processing transfers to step 1410 in which search listing culler 1204 incorporates the absolute score determined in step 1406 or 1408 into an aggregate absolute score for the subject search listing. In one embodiment, search listing culler 1204 maintains an arithmetic average of absolute scores from filtered click records. Search listing culler 1204 (FIG. 12) maintains aggregate absolute scores in a absolute scores database 920 (FIG. 9) in scores 916. After step 1410 (FIG. 14), processing according to logic flow diagram 1308, and therefore step 1308 (FIG. 13), completes.

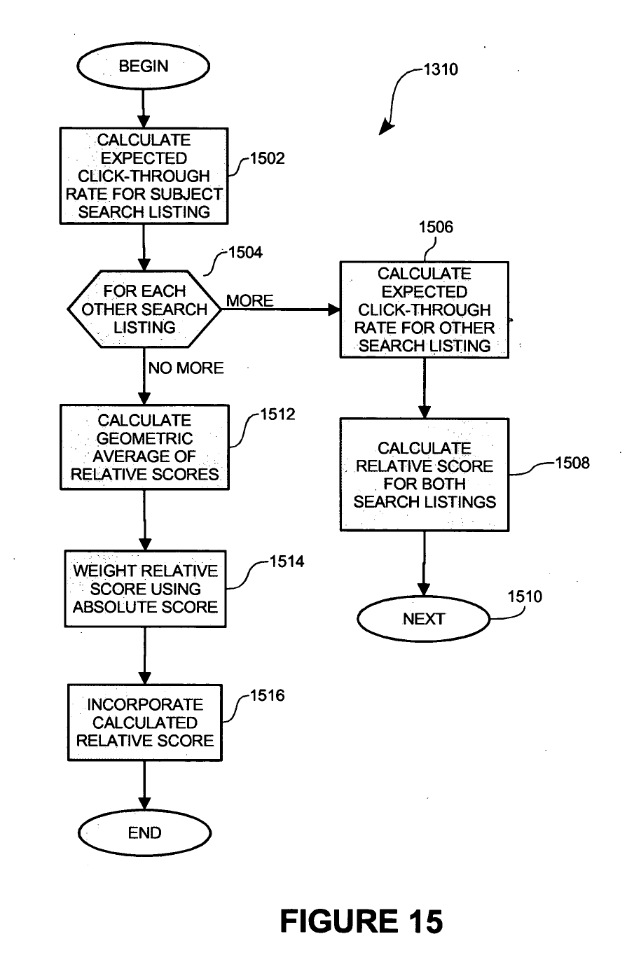

In step 1310, search listing culler 1204 (FIG. 12) updates the relative score for the subject search listing. Step 1310 is shown in greater detail as logic flow diagram 1310 (FIG. 15). In step 1502, search listing culler 1204 determines the expected click through rate for the subject search listing in the manner described above with respect to step 1402 (FIG. 14).

Loop step 1504 (FIG. 15) and next step 1510 define a loop in which search listing culler 1204 (FIG. 12) processes each search listing of the subject search other than the subject search listing according to steps 1506-1508. During each iteration of the loop of steps 1504-1510, the particular search listing is sometimes referred to as the other'search listing and is different from the subject search listing.

In step 1506 (FIG. 15), search listing culler 1204 (FIG. 12) determines the expected click-through rate for the other search listing in the manner described above for the subject search listing.

In step 1508 (FIG. 15), search listing culler 1204 (FIG. 12) determines a relative score between the subject search listing and the other search listing. In this illustrative embodiment, the relative score is given by the following equations in which (i) x represents the position of the other search listing within the subject search, (ii) r represents the position of the subject search listing within the subject search, (iii) C represents the set of clicks collected in step 1304 (FIG. 13), and (iv) b represents the number of search listings in the subject search:
2-P[(x∉C|r∈C)|b], if r∈C and x∉C (1)
1-P[(x∉C|r∈C)|b], if r∈C and x∈C (2)
2-P[(x∉C|r∉C)|b], if r∉C and x∉C (3)
1-P[(x∉C|r∉C)|b], if r∉C and x∈C (4)

To determine values in equations (1) and (2), search listing culler 1204 exploits the following equivalency:

$$P ⌊ ( x ∉ C \vert r ∈ C ) \vert b ⌋ = 1 - P \vert ( x ∈ C \vert r ∈ C ) \vert b ⌋ = 1 - \frac{P ( x ∈ C , r ∈ C ∣ b )}{P ( r ∈ C ∣ b )} \qquad ( 5 )$$

In equation (5), P(r∈C|b)—representing the probability that the subject search listing is clicked given the number of results of the subject search—is estimated using the expected click-through rate determined in step 1502. P(x∈C, r∈C|b)—representing the probability that both the subject search listing and the other search listing are clicked given the number of results of the subject search—is estimated using a relative click through history table 914 (FIG. 9). History table 914 stores a total number of times two search listings at respective positions within a search of a specific length have both been clicked by a user for all searches represented in search file 904. For example, relative click through history table 914 represents a total number of times the second and third search listings of searches having five search listings in the result set. From relative click through history table 914, search listing culler 1204 retrieves the total number of times that search listings at the respective positions of the subject search listing and the other search listing have been selected from search result sets of the length of the result set of the subject search. Search listing culler 1204 divides that number by the total number of searches of the length of the subject search to estimate P(x∈C, r∈C|b). Thus, equation (5) is used to determine the relative score in cases in which equations (1) or (2) are applicable.

To determine values in equations (3) and (4), search listing culler 1204 exploits the following equivalency:

$$\begin{matrix}P [ ( x ∉ C ∣ r ∉ C ) ∣ b ] = 1 - P [ ( x ∈ C ∣ r ∉ C ) ∣ b ∣ \\ = 1 - \frac{P ( x ∈ C , r ∉ C ∣ b )}{P ( r ∉ C ∣ b )} \\ = 1 - \frac{[ P ( x ∈ C ∣ b ) - P ( x ∈ C , r ∈ C ∣ b ) ]}{[ 1 - P ( r ∈ C ∣ b ) ]}\end{matrix} \qquad ( 6 )$$

In equation (6), P(r∈C|b) and P(x∈C, r∈C|b) and are estimated in the manner described above with respect to equations (1) and (2). In addition, P(x∈C|b)—representing the probability that the other search listing is clicked given the number of results of the subject search—is estimated using the expected click-through rate of the other search listing determined in step 1506. Thus, equation (6) is used to determine the relative score in cases in which equations (3) or (4) are applicable.

Equations (1)-(4) generally penalize the subject search listing when search listings other than the subject search listing are selected by the user. Equations (2) and (4) generally penalize more heavily since they represent searches in which the other search listing was selected by the user.

Once all search listings of the subject search other than the subject search listing have been processed according to the loop of steps 1504-1510, processing transfers to step 1512 in which search listing culler 1204 combines all relative scores determined for the subject search listing in the iterative performances of step 1508. In this illustrative example, search listing culler 1204 combines the relative scores using a geometric average of the relative scores. In step 1514, search listing culler 1204 weights the combined relative score of the subject search listing to produce a relative score for the subject search listing.

In step 1516, search listing culler 1204 incorporates the relative score into an aggregate relative score for the subject search listing. In one embodiment, search listing culler 1204 maintains an arithmetic average of relative scores from filtered click records and from searches which includes more than a single search listing in the result set. Search listing culler 1204 (FIG. 12) maintains aggregate relative scores in a relative scores database 918 (FIG. 9) in scores 916. After step 1516, processing according to logic flow diagram 1310, and therefore step 1310 (FIG. 13), completes.

Updating either the aggregate absolute score or the aggregate relative score of a search listing is considered a triggering event which triggers a test for removal of the search listing.

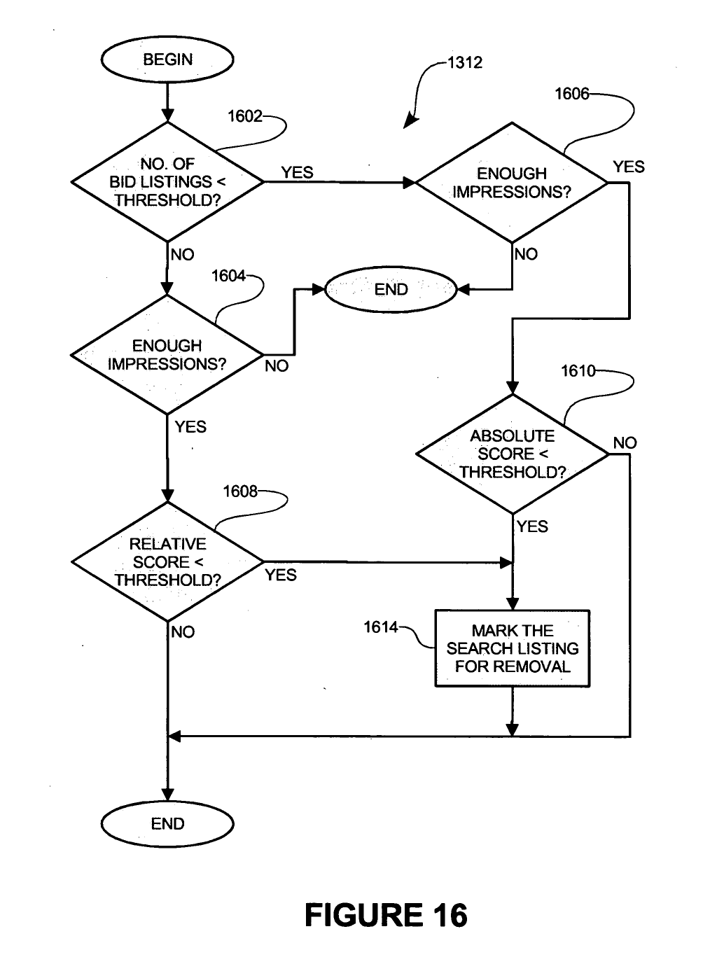

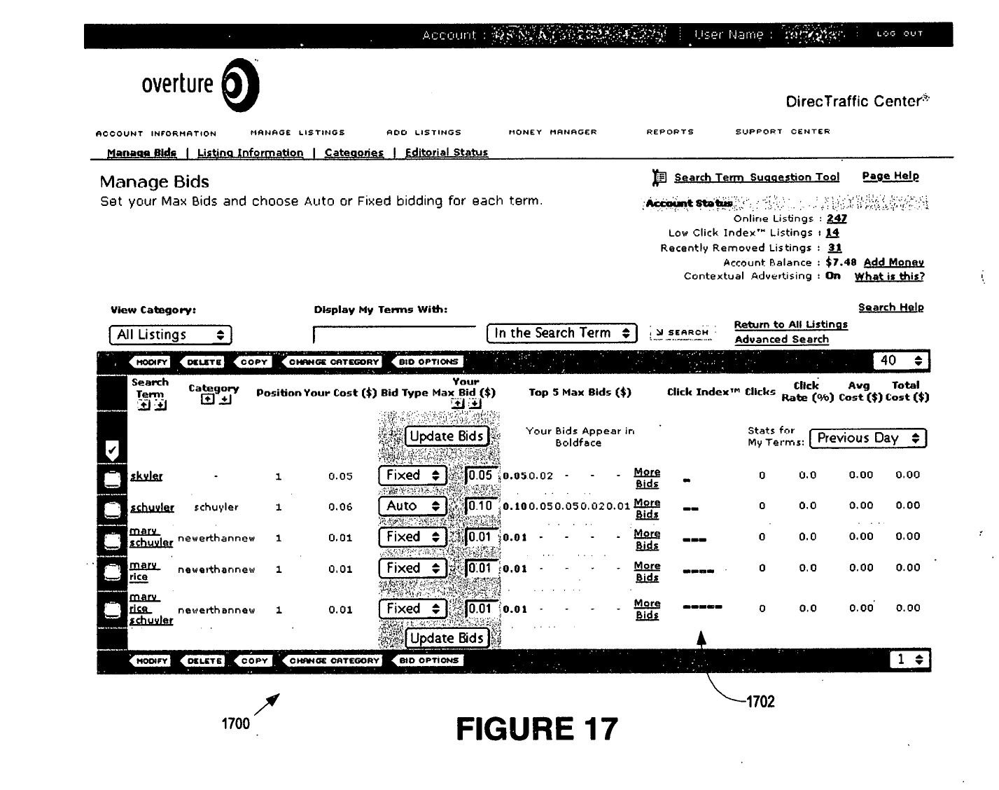

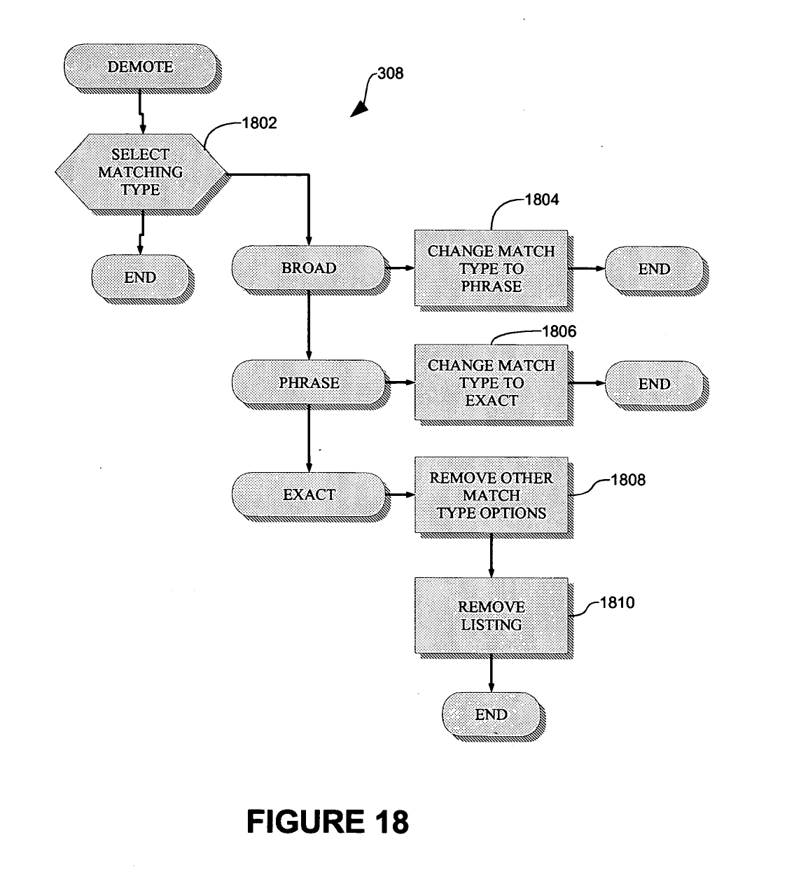

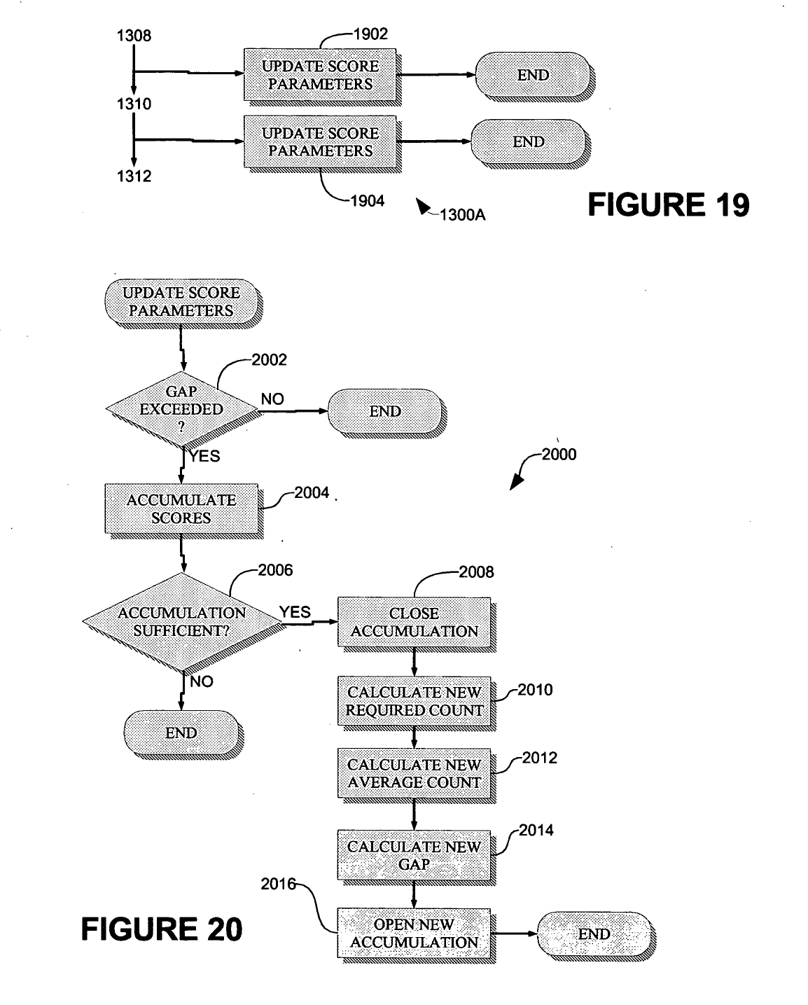

In this illustrative embodiment, search listing culler 1204 performs such a test in step 1312. In an alternative embodiment, search listing culler 1204 places search listings for which aggregate absolute and/or relative scores have been updated into a queue for subsequent testing of those scores for possible removal. In either case, testing for removal of the subject search listing is performed in the manner illustrated in logic flow diagram 1312 (FIG. 16) which shows step 1312 in greater detail.

In test step 1602, search listing culler 1204 (FIG. 12) determines whether the number of bid listings in the subject search are at least a predetermined minimum threshold. The general purpose of test step 1602 is to determine whether a sufficient number of other bid search listings are displayed to make a relative score an appropriate measure of performance in the subject search or an absolute score, which is generally independent of performance of other search listings in the subject search, is a better measure. As described above, this illustrative embodiment processes search listings which are bid and which are unbid. In this illustrative embodiment, unbid listings are discovered by search engine 102 using conventional techniques, sometimes referred to as “crawling,” while bid listings are submitted by owners of the bid listings for inclusion in search database 208. Accordingly, bid listings are more suspect and are therefore more carefully scrutinized, and the predetermined minimum threshold pertains only to bid search listings in this illustrative embodiment. In alternative embodiments, the number of unbid search listings or all search listings can be used as a determinant as to whether absolute or relative scores are more telling in the context of the subject search. The predetermined minimum threshold is stored in parameters 922 (FIG. 9).

If the number of bid listings is below the predetermined minimum threshold, the absolute score of the subject search listing is determined to be the better measure of performance and processing by search listing culler 1204 proceeds to test step 1606. Conversely, if the number of bid listings in the subject search is at least the predetermined minimum threshold, the relative score is determined to be the better measure of performance and processing by search listing culler 1204 proceeds to test step 1604.

For each of relative scores and absolute scores, a respective predetermined minimum number of impressions is stored in parameters 922 (FIG. 9). A search listing is not considered for removal until a sufficient number of impressions has been accumulated to provide reasonably reliable statistical analysis in the manner described above. In one embodiment, the predetermined minimum number of impressions is two hundred. In an alternative embodiment, the predetermined minimum number of impressions can vary according to various characteristics of the search listing and/or the search terms for which the search listing is a candidate for serving as a result. For example, different predetermined minimum numbers of impressions can be specified (i) according to the owner of the search listing since some search listing owners may have established greater trust over time; (ii) according to the volume of searches of the particular search term; (iii) according to the marketplace to which the search listing pertains; and (iv) according to the manner in which the search listing was originally approved for inclusion in search database 208, namely, by human editorial review or by automated editorial review.

In test step 1604 or 1606, if the number of impressions of the subject search listing is below the predetermined threshold for relative scores or absolute scores, respectively, processing according to logic flow diagram 1312, and therefore step 1312 (FIG. 13), completes and the subject search listing is not removed. In such a case, the subject search listing is in either accumulation state 602 (FIG. 6) or probate state 608. Conversely, if the number of impressions of the subject search listing is at least the predetermined threshold for relative scores or absolute scores, respectively, processing transfers to test step 1608 (FIG. 16) or 1610, respectively, and the subject search listing is in evaluation state 604 (FIG. 6).

For each of relative scores and absolute scores, a respective predetermined minimum threshold score is stored in parameters 922 (FIG. 9). A search listing is marked for removal if the search listing has the prerequisite number of impressions and a score below the predetermined minimum score. In one embodiment, the predetermined minimum score is 46.5. In an alternative embodiment, the predetermined minimum number of impressions can vary according to various characteristics of the search listing. For example, different predetermined minimum score can be specified (i) according to the owner of the search listing since some search listing owners may have established greater trust over time; (ii) according to the volume of searches of the particular search term; (iii) according to the marketplace to which the search listing pertains; and (iv) according to the manner in which the search listing was originally approved for inclusion in search database 208, namely, by human editorial review or by automated editorial review.

In test step 1608 or 1610, if the aggregate relative or absolute score, respectively, of the subject search listing is below the predetermined threshold score for relative scores or absolute scores, respectively, processing transfers to step 1614 in which search listing culler 1204 marks the subject search listing for removal by representing the subject search listing in removal table 924. Such represents a transition of the subject search listing to warning state 606. In one embodiment, a search listing failing to achieve the predetermined minimum absolute score is not automatically removed but is instead either automatically modified or flagged for review by a human editor. Conversely, if the aggregate relative or absolute score, respectively, of the subject search listing is at least the predetermined threshold score for relative scores or absolute scores, respectively, processing according to logic flow diagram 1312, and therefore step 1312 (FIG. 13), completes and the subject search listing is not removed.

Thus, a search listing is only marked for removal from search database 208 when its number of impressions has reached a predetermined minimum and its score has dropped below a predetermined permissible threshold. If only a few search listings are presented in conjunction with the subject search listing, an absolute score is used rather than a relative score.

After step 1312 (FIG. 13), the next search listing of the subject search is processed according to the loop of steps 1306-1314. After all search listings of the subject search have been processed according to the loop of steps 1306-1314, processing by search listing culler 1204 transfers through next step 1316 to loop step 1302 in which search listing culler 1204 processes the next search according to steps 1304-1314. When all searches of search file 904 have been processed by search listing culler 1204, processing according to logic flow diagram 1300 completes.

Performance monitor 212 includes a search listing removal agent 1208 which detects search listings added to removal table 924 and removes them from search database 208. Such detecting can be by (i) periodically checking removal table 924 for new entries, (ii) receiving a signal from search listing culler 1204 when new entries are added to removal table 924, or (iii) using a trigger-based event detection mechanism when new entries are written to removal table 924, for example.

It is preferred that the substance of any removed search listings be preserved since such search listings can be subsequently reinstated in search database 208. The substance of search listings can be represented entirely within removal table 924 or the search listings can remain stored in search database 208 while being virtually removed by associating a flag with search listings to indicate that they are not available for inclusion in search result sets. In addition, removed search listings can be entirely represented within data structures independent of both search database 208 and removal listing 924.

Search listing removal agent 1208 also communicates removal of the search listings represented in removal table 924 to removal notification agent 1206. Removal notification agent 1206 notifies both the owner of the removed search listing and a human editor associated with search engine 102 of the removal. The notification to the search listing owner is by e-mail in this illustrative embodiment and includes reasons for removal—including the performance scores of the removed search listing and, in circumstances in which suggestions for modification are available, suggestions for modification of the search listing. Such enables the owner to reconsider the nature of the inter-relationships between the search term, URL, title, and description of the removed search listing. Notification to the human editor, or alternatively to a computer-implemented editor, is in the form of a report of removed search listings and associated performance scores in this illustrative embodiment. Such a report enables the editor to evaluate the performance of performance monitor 212 by checking to see if proper search listings are being unfairly removed from search database 208.

Performance monitor 212 also includes a search listing modification agent 1210 which applies automatic modification profiles to search listings in the manner described above with respect to steps 306-310 (FIG. 3).

Screen view 1700 (FIG. 17) shows a display of a web-based account management application as described above with respect to FIG. 6. Screen view 1700 includes a bar graph 1702 showing scored performance of respective search listings managed by a single owner. Bar graph 1702 presents performance evaluation to the owner of the search listings in an easily understood and intuitively accessible manner. Specifically, bar graph 1702 graphically represents evaluated performance of the respective search listings as a series of zero to five dashes. Three dashes represent generally average performance. Five dashes represent much better than average performance. Representation of no dashes indicates much worse than average performance. In an alternative embodiment, representation of no dashes indicates a search listing in either accumulation state 602 (FIG. 6) or probation state 608 and a single dash represents a search listing in warning state 606. If a bar graph includes only a single dash, that dash is shown in the color red to draw attention to particularly poor performing search listings. Otherwise, dashes of bar graphs including two or more dashes are shown in blue in this illustrative embodiment.

In this embodiment, bar graph 1702 (FIG. 17) represents either the aggregate absolute score or the aggregate relative score of the associated search listing selected in the manner described above with respect to logic flow diagram 1312 (FIG. 16). The represented performance scores are retrieved at the time screen view 1700 (FIG. 17) is composed for display to the user such that the information represented by bar graph 1702 is quite current. For example, if the owner of the search listings of screen view 1700 issues a refresh display instruction to re-compose screen view 1700, any changes in the performance scores of bar graph 1702 are modified to reflect any changes in the performance scores since the prior composition of screen view 1700, e.g., due to serving of one or more of the search listings in sets of results in response to one or more searches.

In another embodiment, there are variations of screen view 1700 including a detailed view and a summary view for various marketplaces. The following table summarizes representations of performance scores by bar graph 1702 in the United States marketplace in the detailed view.

| Range | Graphical Representation | |
|---|---|---|
| 0.00-27.99 | No | bars. |
| 28.00-36.79 | 1 | bar. |
| 36.80-45.59 | 2 | bars. |
| 45.60-54.39 | 3 | bars. |
| 54.40-63.19 | 4 | bars. |
| 63.20-100.00 | 5 | bars. |

The following table summarizes representations of performance scores by bar graph 1702 in the United States marketplace in the summary view.

| Range | Graphical Representation | |
|---|---|---|
| 0.00-33.99 | No | bars. |
| 34.00-40.39 | 1 | bar. |
| 41.40-46.79 | 2 | bars. |
| 46.80-53.19 | 3 | bars. |
| 53.20-59.59 | 4 | bars. |
| 59.60-100.00 | 5 | bars. |

The following table summarizes representations of performance scores by bar graph 1702 in all marketplaces other than the United States.

| Range | Graphical Representation | |
|---|---|---|
| 0.00-9.99 | No | bars. |
| 10.00-25.99 | 1 | bar. |
| 26.00-41.99 | 2 | bars. |
| 42.00-57.99 | 3 | bars. |
| 58.00-73.99 | 4 | bars. |
| 74.00-100.00 | 5 | bars. |

As described above, automatic modification of the search listing can include demotion of a type of search of a search listing to thereby improve performance of the search listing without removing the search listing or requiring human intervention. In this particular embodiment, three types of searches are supported: broad matching, phrase matching, and exact matching. For the sake of illustration, it is helpful to consider an example. In this example, the search term is “patent services.”

In exact matching, only exactly the search query “patent services” matches the search term. Other search queries which include both “patent” and “services”—e.g., “discount patent services” and “intellectual property services patent trademark copyright”—do not match.

In phrase matching, any search query which includes all words of the search term, preserving contiguity and order of the words, matches the search term. For example, “discount patent services” preserves the contiguity of both words of “patent services” and includes them in the same order. Therefore, under phrase matching, the search term “patent services” matches the search query “discount patent services.” The search term “intellectual property services patent trademark copyright” preserves neither the contiguity nor the order of the words of the search term “patent services” and therefore is not matched in phrase matching. Thus, phrase matching is a more generalized matching mechanism than is exact matching, and conversely exact matching is a more specific matching mechanism than is phrase matching.

In broad matching, any search query which includes all words of the search term, irrespective of contiguity and order, is matched by the search term. In this example, all search queries match the search term “patent services” as each includes both “patent” and “services”: “patent services”, “discount patent services”, and “intellectual property services patent trademark copyright”. Thus, broad matching is a more generalized matching mechanism than is phrase matching, and conversely phrase matching is a more specific matching mechanism than is broad matching.

This example further illustrates the advantage of search type demotion as an effective automated modification of an under-performing search listing. Consider that the search listing whose term is “patent services” is configured to use broad matching in matching the search listing to search queries. The search listing may perform below acceptable levels if it is served in response to search queries pertaining to broader types of intellectual property such as trademarks, copyrights, and trade secrets. Rather than removing the under-performing search listing, the search listing is demoted such that phrase matching is used instead of broad matching. Such gives the search listing a chance to perform at an acceptable level with respect to search queries more closely related to the search term of the search listing. Such demotion is shown by logic flow diagram 308 (FIG. 18) which shows step 308 (FIG. 3) in greater detail according to this embodiment.

In select step 1802 (FIG. 18), search listing modification agent 1210 (FIG. 12) determines the type of matching currently applied to the search listing: broad, phrase, or exact matching.

If broad matching is currently applied to the search listing, processing by search listing modification agent 1210 transfers to step 1804 (FIG. 18) in which search listing modification agent 1210 changes the applicable type of matching to phrase matching. In this illustrative embodiment, search listing modification agent 1210 (FIG. 12) changes the type of applicable matching by marking the search listing as ineligible for broad matching. According, the broadest form of matching available to the search listing is phrase matching.

If phrase matching is currently applied to the search listing, processing by search listing modification agent 1210 transfers to step 1806 (FIG. 18) in which search listing modification agent 1210 changes the applicable type of matching to exact matching. In this illustrative embodiment, search listing modification agent 1210 (FIG. 12) changes the type of applicable matching by marking the search listing as ineligible for both broad and phrase matching. According, the broadest form of matching available to the search listing is exact matching.

If exact matching is currently applied to the search listing, processing by search listing modification agent 1210 transfers to step 1808 (FIG. 18) in which search listing modification agent 1210 marks the search listing as ineligible for both broad and phrase matching. According, the broadest form of matching available to the search listing is exact matching. In step 1810, search listing modification agent 1210 marks the search listing for removal. The processing of a search listing marked for removal is as described above and can include, for example, putting the search listing on probation for a period of time to allow the owner of the search listing to make modifications to the search listing to thereby improve future performance of the search listing.

The varying types of matching allow owners of search listing to request the broadest possible applicability of their search listings to thereby maximize exposure to a wider audience. By using demotion of matching types for under-performing search listings, a search listing is given multiple opportunities to perform at an acceptable level before requiring intervention by the owner of the search listing and/or removal of the search listing.

As described briefly above, several parameters of performance evaluation are dynamic, adjusting according to the search volume of individual search listings. Those parameters include (i) the minimum number of impressions of the search listing required before performance of the search listing is evaluated (sometimes referred to herein as a “required count”), (ii) the number of most recent impressions to consider in determining the absolute score (sometimes referred to herein as an “average count”), and (iii) the minimum amount of time between impressions to be included in determination of the absolute score (sometimes referred to herein as a “gap”). Modification of these parameters in the context of logic flow diagram 1300 (FIG. 13) is shown as logic flow diagram 1300A (FIG. 19). Briefly, adjustment of the parameters for absolute scores is performed in step 1902, which is performed after determination of the absolute score in step 1308. Similarly, adjustment of the parameters for relative scores is performed in step 1904, which is performed after determination of the relative score in step 1310. Step 1902 is directly analogous to step 1904 and description below of step 1902 is equally applicable to step 1904 except where noted below.

Step 1902 is shown in greater detail as logic flow diagram 1902 (FIG. 20). In test step 2002, search listing culler 1204 determines whether the current gap has been exceed since the most recent performance of step 2004. In this illustrative embodiment, the gap is initially set to one minute and remains one minute until search listing culler 1204 modifies it in the manner described below in step 2014. Thus, only scores which are at least one minute apart are accumulated in the manner described below. If the gap has not been exceeded, processing transfers according to logic flow diagram 1902, and therefore step 1902 (FIG. 19), completes.

Conversely, if sufficient time as defined by the gap has elapsed since the last accumulated score, processing transfers to step 2004 (FIG. 20) in which search listing culler 1204 accumulates the most recently determined absolute score of the subject search listing. As described more completely below, the required count, average count, and gap are adjusted according a ratio of number of scores to time—essentially, a rate of score accumulation. To provide a somewhat statistically reasonable ratio of scores to time, scores are accumulated over time until a minimum number of scores and a minimum amount of time have accumulated. Search listing culler 1204 determines whether a sufficient number of scores and a sufficient amount of time have accumulated. In this illustrative embodiment, the minimum number of accumulated scores is eight (8) and the minimum amount of accumulated time is one hour. Thus, if fewer than eight (8) scores have been accumulated in prior performances of step 2004 or less than one hour has elapsed since scores have been accumulating, processing according to logic flow diagram 1902, and therefore step 1902 (FIG. 19), completes.

Conversely, if at least eight (8) scores have accumulated in step 2004 (FIG. 20) and at least one hour has passed since accumulation of these eight (8) scores started, processing transfers to step 2008. In step 2008, search listing culler 1204 closes the current accumulation, i.e., disallows additional scores to be added to the accumulation in subsequent performances of step 2004. In step 2010, search listing culler 1204 calculates a new required count. In this illustrative embodiment, search listing culler 1204 calculates the new required count according to the following equation:

$$Required Count = warning period \times ( \frac{avg . no . of accumulated scores}{avg . time between accumulations} ) \qquad ( 7 )$$

In equation (7), the warning period is expressed in a number of minutes for which the owner of the search listing is warned prior to removal and/or demotion of the search listing. In this illustrative embodiment, the warning period is 5,760 minutes, i.e., four (4) days. In addition, the three (3) most recently closed accumulations of scores are used in equation (7). Each accumulation is sometimes referred to as a bucket herein. A bucket has a number of scores accumulated in various performances of step 2004 and an amount of time elapsing between the closing of the prior bucket in step 2008 and the closing of the current bucket in the most recent performance of step 2008. Low volume search listings will tend to have buckets with eight (8) accumulated scores and bucket periods of greater than one hour. Similarly, high volume search listings will tend to have buckets with more than eight (8) accumulated scores and bucket periods of about one hour. A moderate volume search listing with close to eight (8) accumulated scores per bucket and bucket periods close to one hour each will have a calculated new required count of 768. In this illustrative embodiment, required counts are not permitted to be below predetermined minimums or above predetermined maximums. The predetermined minimum and maximum for absolute scores are 400 and 1600, respectively. The predetermined minimum and maximum for relative scores are 180 and 1600, respectively.

In step 2012, search listing culler 1204 calculates a new average count for the subject search listing. In this illustrative embodiment, the new average count is twice the new required count determined in step 2010. Search listing culler 1204 does not allow average counts to exceed the predetermined maximum of 2,024 for either absolute or relative scores. Since the average count is proportional to the required count, the average count is similarly related to a ratio of the number of accumulated scores to time.

In step 2014, search listing culler 1204 calculates a new gap for the subject search listing. In this illustrative embodiment, the new gap is determined according to the following equation:

$$gap = ( \frac{Required Count}{warning period} ) \times 0.5 \qquad ( 8 )$$

Using equation (7), equation (8) can be shown to be equivalent to:

$$gap = ( \frac{avg . time between accumulations}{avg . no . of accumulated scores} ) \times 0.5 \qquad ( 9 )$$

The values shown in equation (9) are determined in the manner described above with respect to step 2010. It can be seen in equation (9) that the gap is shorter for high-volume search listings, thereby accepting a greater number of scores in a shorter amount of time, and longer for low-volume search listings. In particular, the gap is inversely related to a ratio of the number of accumulated scores to time. Search listing culler 1204 does not permit gaps shorter than a predetermined minimum of one minute in this illustrative embodiment.

In step 2016, search listing culler 1204 opens a new accumulation, i.e., a new bucket, into which to accumulate additional scores in subsequent performances of the steps of logic flow diagram 1902.

Thus, the required count, average count, and gap for both absolute and relative scores are adjusted according to search volume as such scores are accumulated. Such allows low-volume search listings to be evaluated relatively quickly to avoid prolonged exposure of poor search listngs in served search results while simultaneously allowing high-volume search listing to accumulate a statistically significant number of impressions prior to removing the high-volume search listing.

The above description is illustrative only and is not limiting. The present invention is defined solely by the claims which follow and their full range of equivalents.

1. A method for improving the performance of search listings, the method comprising:
determining a frequency of selection of a subject one of the search listings in one or more sets of search results;
comparing the frequency of selection to a minimum permissible frequency;
making the subject search listing unavailable as a result in a search upon a condition in which the frequency of selection is less than the minimum permissible frequency; and
determining a minimum count according to an impression frequency with which the subject search listing is presented in response to a search query;
wherein comparing is performed only upon a condition in which the subject search listing has been presented as a result of one or more searches a number of times which is no less than the minimum count.

2. The method of claim 1 wherein determining comprises:
determining the frequency of selection of the subject search listing in the one or more sets of search results according to respective positions of the subject search listing in the one or more sets of search results.

3. The method of claim 1 wherein determining comprises:
determining the frequency of selection of the subject search listing in the one or more sets of search results according to respective positions of the subject search listing in the one or more sets of search results and further according to respective frequencies of selection of one or more search listings at respective other positions within the one or more sets of search results.

4. A method for improving the performance of search listings, the method comprising:
determining a maximum count according to an impression frequency with which a subject one of the search listings is presented in response to a search query;
determining a frequency of selection of the subject search listing in a number of sets of search results most recently presented to one or more users wherein the number of the sets is no more than the maximum count;
comparing the frequency of selection to a minimum permissible frequency; and
making the subject search listing unavailable as a result in a search upon a condition in which the frequency of selection is less than the minimum permissible frequency.

5. The method of claim 4 wherein determining comprises:
determining the frequency of selection of the subject search listing in the one or more sets of search results according to respective positions of the subject search listing in the one or more sets of search results.

6. The method of claim 4 wherein determining comprises:
determining the frequency of selection of the subject search listing in the one or more sets of search results according to respective positions of the subject search listing in the one or more sets of search results and further according to respective frequencies of selection of one or more search listings at respective other positions within the one or more sets of search results.

7. A method for improving the performance of search listings, the method comprising:
determining a frequency of selection of a subject one of the search listings in one or more sets of search results;
comparing the frequency of selection to a minimum permissible frequency;
upon a condition in which the frequency of selection is less than the minimum permissible frequency, modifying the subject search listing from a generalized matching mechanism to a more specific matching mechanism.

8. The method of claim 7 further comprising:
repeating determining and comparing with the subject search listing as modified prior to making the subject search listing unavailable.
